(19) United States
(12) Patent Application Publication
(10) Pub. No.: US 2014/0066093 A1
(43) Pub. Date: Mar. 6, 2014

(54) APPARATUS AND METHOD FOR POSITION DETECTION AND COMMUNICATION OF A DEVICE

(71) Applicant: Pantech Co., Ltd., Seoul (KR)

(72) Inventors: Ji Oh YOO, Seoul (KR); Won Tae Kim, Seoul (KR); Yoon Jung Seo, Seoul (KR)

(73) Assignee: Pantech Co., Ltd., Seoul (KR)

(21) Appl. No.: 13/954,261

(22) Filed: Jul. 30, 2013

(30) Foreign Application Priority Data
Sep. 5, 2012 (KR) 10-2012-0098035

(51) Int. Cl. G01S 5/00

(52) U.S. Cl. CPC G01S 5/0018
USPC 455/456.1

(57) ABSTRACT

Terminals, apparatuses and methods for position detection and communication of a device performed at a device may include setting a starting position, measuring or determining a positional change amount from the starting position, and calculating or determining a current position of the host device based on the positional change amount, and sharing the calculated or determined current position through communication with an external device. Also, terminals, apparatuses and methods for position detection and communication may include setting a position sharing group including a the terminal and at least one corresponding device, setting a starting position of the terminal through communication with the at least one of a corresponding device or a server device associated with the position sharing group, and verifying a current position of the terminal and a current position of the at least one corresponding device based on the set starting position.

### CROSS-REFERENCE TO RELATED APPLICATION

This application claims priority to and the benefits under 35 U.S.C. §119 of Korean Patent Application No. 10-2012-0098035, filed on Sep. 5, 2012, the contents of which are herein incorporated in its entirety by reference for all purposes as if fully set forth herein.

### BACKGROUND

1. Field

Exemplary embodiments of the present invention relate to position detection and communication of a device, and more particularly, to apparatuses and methods for performing one or more of position detection and communication between devices.

2. Discussion of the Background

A current position of a device may be verified using global positioning system (GPS) information. The device may be aware of a current longitude and latitude using the GPS information. The device may verify or determine a mutual position with a corresponding device by sharing GPS information with the corresponding device.

GPS information may be obtained using a GPS satellite signal. However, in an environment in which a GPS satellite signal is not received, a device may not accurately verify a current position of a device. Therefore, when it is difficult to receive a GPS satellite signal, for example, in an indoor environment, position information may be difficult to be shared between devices.

Due to a characteristic of a civilian GPS satellite signal, an error range is typically about 30 meters. And, as such, it may be impossible or difficult to use the civilian GPS satellite signal in a narrow indoor environment. Accordingly, in an indoor environment, it may be impossible or difficult to verify a mutual position between devices using GPS information.

Even though an indoor positioning system may be used to verify a position of a device indoors, a plurality of external devices, for example, a wireless local area network (WLAN) and Bluetooth, may be required and additional information, for example, indoor map information in which a corresponding position is stored, may likewise be required.

### SUMMARY

Exemplary embodiments of the present invention provide apparatuses and methods for performing one or more of position detection and communication of a device, such as to perform communication between devices, such as a mobile terminal.

Exemplary embodiments relate to a terminal to perform position detection and communication, including: a sensing unit to determine a positional change amount of the terminal from a starting position; a position calculating unit to determine a current position of at least one of the terminal or a host device based on the determined positional change amount; a control unit to set a starting position of the terminal and to update the current position of the terminal, and to control performing position detection and communication of the terminal; and a communication unit to share the determined current position through communication with at least one external device.

Exemplary embodiments also relate to a terminal to perform position detection and communication in a position sharing group, including: a position sharing group setting unit to set the position sharing group comprising the terminal and at least one corresponding device; a current position verifying unit to verify a current position of the terminal and the current position of the at least one corresponding device based on a starting position of the terminal; and a control unit to control updating the current position of the terminal and to control performing position detection and communication of the terminal.

Exemplary embodiments further relate to a method for performing position detection and communication of a terminal, including: determining a positional change amount of the terminal with respect to a starting position; determining a current position of at least one of the terminal and a host device based on the determined positional change amount; updating the current position of the terminal based on the determined current position; and sharing the determined current position through communication with at least one external device.

Exemplary embodiments also relate to a method for performing position detection and communication of a terminal in a position sharing group, including: setting a position sharing group including a terminal and at least one corresponding device; setting a starting position of the terminal through communication with the at least one of a corresponding device or a server device associated with the position sharing group; and verifying a current position of the terminal and a current position of the at least one corresponding device based on the set starting position.

Additional features of the invention will be set forth in the description which follows, and in part will be apparent from the description, or may be learned by practice of the invention

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 and FIG. 2 are diagrams to illustrate principles of position detection and communication of a device, according to exemplary embodiments of the present invention.

FIG. 3, FIG. 4, FIG. 5, FIG. 6A, FIG. 6B, FIG. 7A and FIG. 7B are diagrams to illustrate operations of a motion recognizing sensor, according to exemplary embodiments of the present invention.

FIG. 8 is a block diagram illustrating a configuration of an apparatus to perform position detection and communication according to exemplary embodiments of the present invention.

FIG. 9 is a block diagram illustrating a configuration of an apparatus to perform position detection and communication according exemplary embodiments of the present invention.

FIG. 10, FIG. 11, FIG. 12 and FIG. 13 are flowcharts illustrating methods for position detection and communication performed at a host device according to exemplary embodiments of the present invention.

FIG. 14 is a diagram to illustrate concepts of origin correction according to exemplary embodiments of the present invention.

FIG. 15, FIG. 16 and FIG. 17 are flowcharts illustrating methods for position detection and communication performed at a host device according to exemplary embodiments of the present invention.

FIG. 18, FIG. 19, FIG. 20, FIG. 21, FIG. 22. FIG. 23. FIG. 24 and FIG. 25 are diagrams to illustrate operations for generating a position sharing group and detecting a position, according to exemplary embodiments of the present invention.

FIG. 26, FIG. 27, FIG. 28 and FIG. 29 are diagrams to illustrate operations for generating a position detection group and detecting a position using a server device, according to exemplary embodiments of the present invention.

FIG. 30, FIG. 31, FIG. 32, FIG. 33, FIG. 34, FIG. 35, FIG. 36, FIG. 37A, FIG. 37B, FIG. 38, FIG. 39 including images (A) and (B), FIG. 40 including images (A) and (B) and FIG. 41 are diagrams to illustrate applications to perform position detection and communication, according to exemplary embodiments of the present invention.

### DETAILED DESCRIPTION OF THE ILLUSTRATED EMBODIMENTS

Aspects of the present invention are described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present; and, as to wireless communication, “connected to” may be interpreted as being wirelessly connected, such as a wireless connection between a terminal and a base station or external server, for example.

Terms used herein are described or defined based on their operations and, as such, may vary according to users, user's intentions, or practices. Therefore, the definitions or descriptions of the terms should be understood in relation to their use in the specification and should not be construed in a limiting sense.

Hereinafter, an apparatus, such as a terminal, may include, for example, a terminal, a mobile communication terminal, handheld, portable or tablet computer or communication devices, or other apparatuses, for performing position detection and communication, will be described in more detail with reference to the drawings, and should not be construed in a limiting sense. Also, the terminal, and the units, modules, elements, devices and components of the terminals herein described, include hardware and software, and can also include firmware, to perform various operations of the terminal including those for performing position detection and communication, including those described herein, as may be known to one of skill in the art. As such, terminal as used herein should not be construed in a limiting sense and may include the above and other apparatuses for performing position detection and communication.

Also, apparatuses, such as a terminal may include, for example, any of various devices or structures used for wireless or wired communication for performing position detection and communication and can be wired or wireless connected to a base station, server or network, and may include another terminal apparatus or device, and also may include hardware, firmware, or software to perform various operations for performing position detection and communication, including those described herein, as may be known to one of skill in the art.

Hereinafter, an apparatus, such as including, for example, a terminal, a mobile terminal, a mobile communication terminal, handheld, portable or tablet computer or communication devices, or other apparatuses, and methods for performing position detection and communication will be described in more detail with reference to the drawings.

Hereinafter, exemplary embodiments of the present invention for performing position detection and communication will be described with reference to the accompanying drawings.

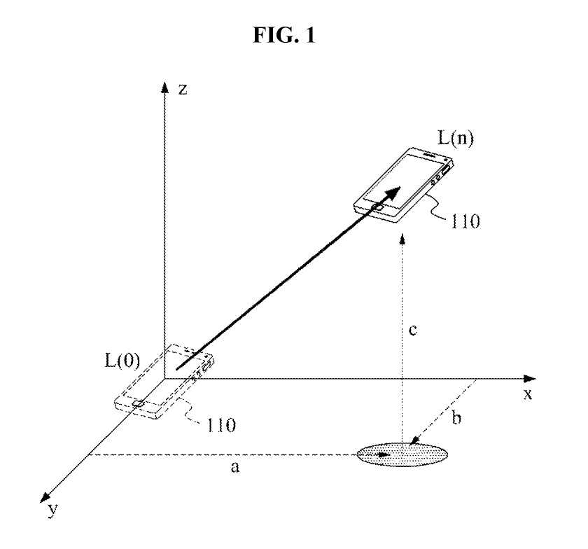

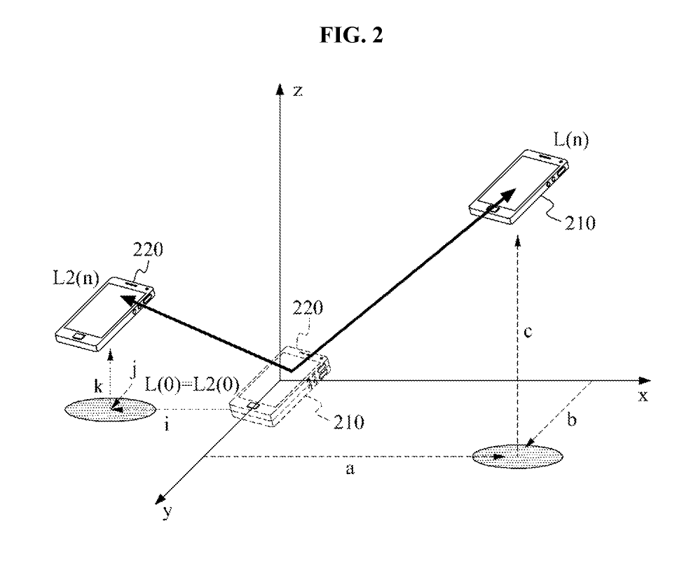

FIG. 1 and FIG. 2 are diagrams to illustrate principles of position detection and communication of a device according to exemplary embodiments of the present invention.

Referring to FIG. 1, a starting position of a device 110 may be indicated as L(0) and a position of the device 110 after an amount n of time is elapsed may be indicated as L(n). L(n) may be expressed, for example, as an accumulated summation of positional change amounts per unit time based on L(0). For example, L(n) may be defined as shown in Equation 1.

$$L ( n ) = ( a , b , c ) = L ( 0 ) + {\sum }_{t = 1}^{n} ( Δ {x}_{t} , Δ {y}_{t} , Δ {z}_{t} ) \qquad [ Equation 1 ]$$

In Equation 1, Δxₜ, Δyₜ, and Δzₜ denote positional change amounts per unit time with respect to an x axial direction, a y axial direction, and a z axial direction, respectively. Therefore, when the starting position L(0) of the device 110 is determined, a current position L(n) to the starting position L(0) may be known by measuring a positional change amount per hour, for example.

In an environment, for example, an indoor environment in which global positioning system (GPS) information is likely to be unavailable, it may be difficult to determine the starting position L(0) without using additional information.

When at least two devices are present and when starting positions of each of the at least two devices are specified as L(0), each of the at least two devices may calculate or determine a current position by measuring a positional change amount. By sharing the current position L(n) through communication between devices, a device may be aware of a position of a corresponding device, according to exemplary embodiments.

In the specification, a device configured to search for a position of the corresponding device may be referred to as a “host device”, for example, but should not be construed in a limiting sense.

Also, in the specification, “external device” may denote a corresponding device or a server device, for example. The server device may be a device that is installed in a reference location to manage connected devices. The server device may also be installed in the reference location to be in a fixed form.

Communication between or among one or more devices may be, for example, near field communication (NFC), various types of wireless local area network (WLAN) communication, wireless-fidelity (Wi-Fi) communication using an access point (AP), Wi-Fi direct communication, Bluetooth communication, infrared (IR) communication, or millimeter communication of at least 60 GHz, for example. Also, devices may share the current position L(n) over a 3rd generation (3G) mobile communication network or a long term evolution (LTE) network, for example.

Referring to FIG. 2, when a starting position L(0) of a first device 210 is physically identical or substantially identical to a starting position L2(0) of a second device 220, a position of a counter party, such as the second device 220 to a position of a party, such as the first device 210, e.g. a host device user's position (“my position’), may be known by comparing a current position L(n) of the first device 210 calculated or determined when an amount n of time is elapsed, with a current position L2(n) of the second device 220, for example.

When the first device 210 and the second device 220 overlap each other, the first device 210 and the second device 220 may be positioned at the physically identical or substantially identical position. Even though the first device 210 and the second device 220 are positioned within a reference range, the first device 210 and the second device 220 may be regarded to be positioned at the physically identical or substantially identical position. While a relatively small error may occur at an origin, the error may be within a range allowable to provide a service, such as a location or communication service, for example.

When the first device 210 is assumed to be a host device, the first device 210 may calculate or determine the current position L(n) using a positional change amount from the starting position L(0). The first device 210 may receive the current position L2(n) of the second device 220 to thereby become aware of the current position L2(n) of the second device 220. The current position L2(n) of the second device 220 may be directly received from the second device 220, or may also be received through a server device (not shown), for example.

In FIG. 2, each of the starting positions L(0) and L2(0) may be defined as an origin of a coordinate system as expressed by Equation 2, for example.

L(0)=(0,0,0)

L2(0)=(0,0,0) [Equation 2]

In FIG. 2, when an amount n of time is elapsed, the current position L(n)=(a, b, c) and the current position L2(n)=(i, j, k).

That L(0) becomes to be identical or substantially identical to L2(0) indicates that positions of devices are present within an identical or substantially identical coordinate system. Accordingly, the first device 210 and the second device 220 may be aware of mutual positions using L(n) and L2(n) of the identical or substantially identical coordinate system, for example.

In an indoor environment in which GPS information is unavailable or relatively unavailable, when the following three conditions are satisfied, a device may detect a position of a corresponding device, such as the first device 210 detecting a position of the second device 220, for example.

As a first condition, it is possible to calculate or determine a current position from a starting position by measuring a positional change amount and performing the calculation or determination using the measured positional change amount.

As a second condition, a starting position of a host device is identical or substantially identical to a starting position of a corresponding device.

And, as a third condition, the host device and the corresponding device may share mutual current position information through communication.

In this regard, each of the first device 210 and the second device 220 may include a motion recognizing sensor. The motion recognizing sensor may include, for example, an acceleration sensor, a gyro sensor, and a terrestrial magnetism sensor, for example. And the positional change amount may be calculated or determined using the motion recognizing sensor.

For example, it is possible to be aware of acceleration in a movement direction using the acceleration sensor. When the acceleration is integrated based on a unit time and thereby is calculated or determined, a movement distance into each direction may be obtained. Also, it is possible to distinguish each direction, such as based on the directions east, west, south, and north and thereby correct each direction using the terrestrial magnetism sensor, for example. Using the gyro sensor, it is possible to measure a change amount of angular velocity of a device and thereby calculate or determine and correct a positional change amount based on a direction and a motion of the device.

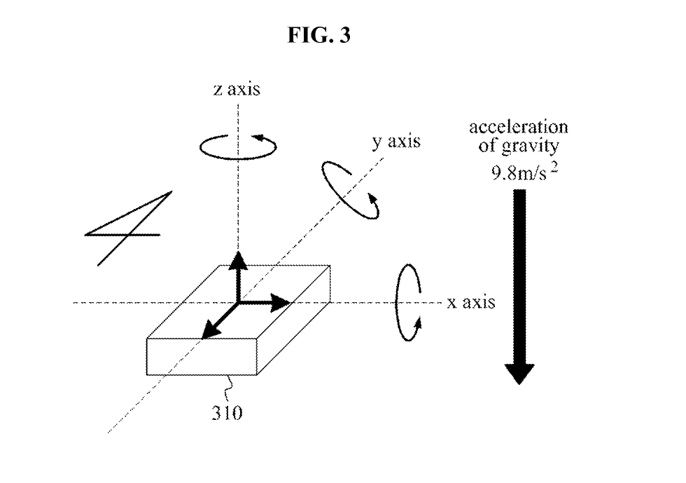

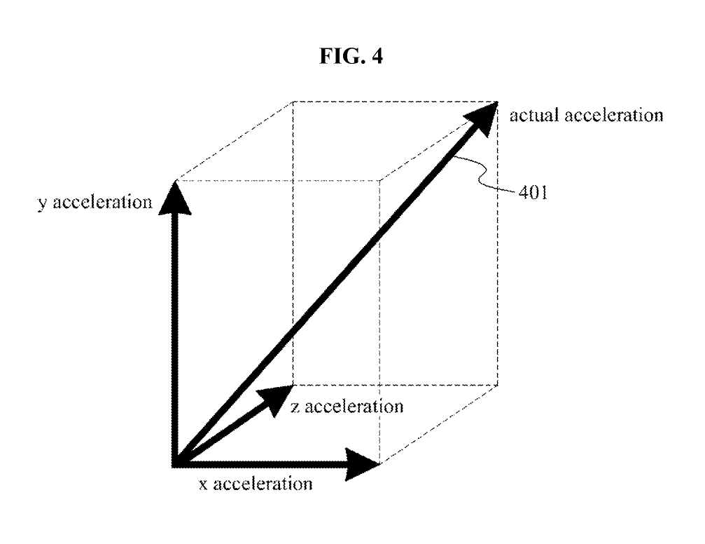

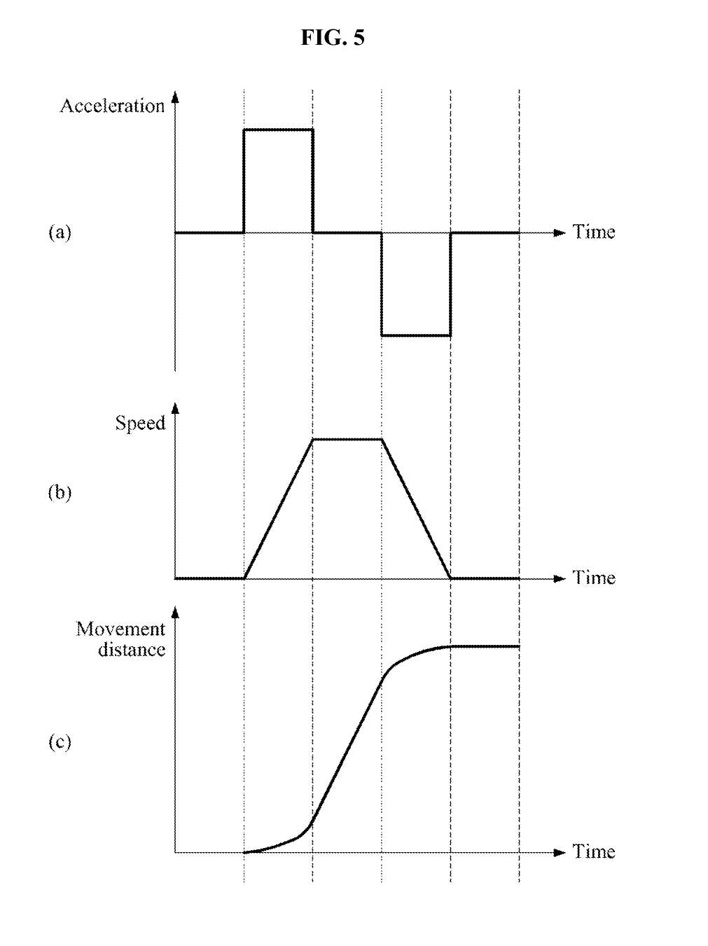

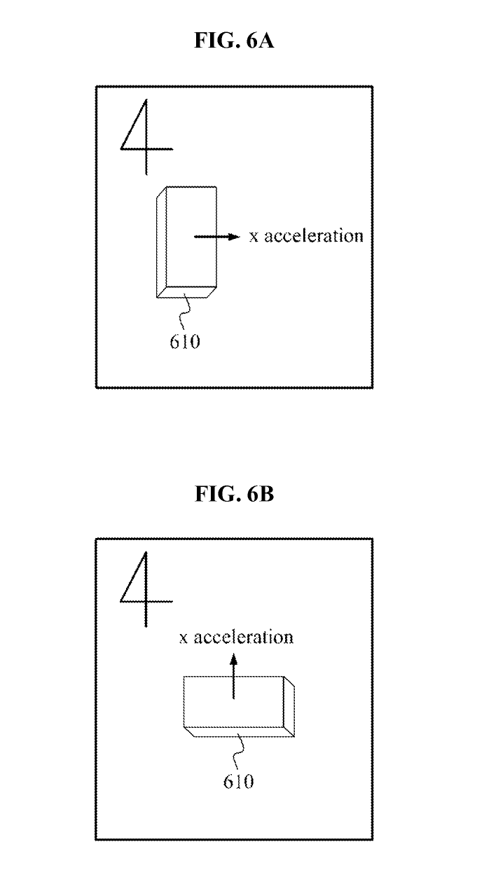

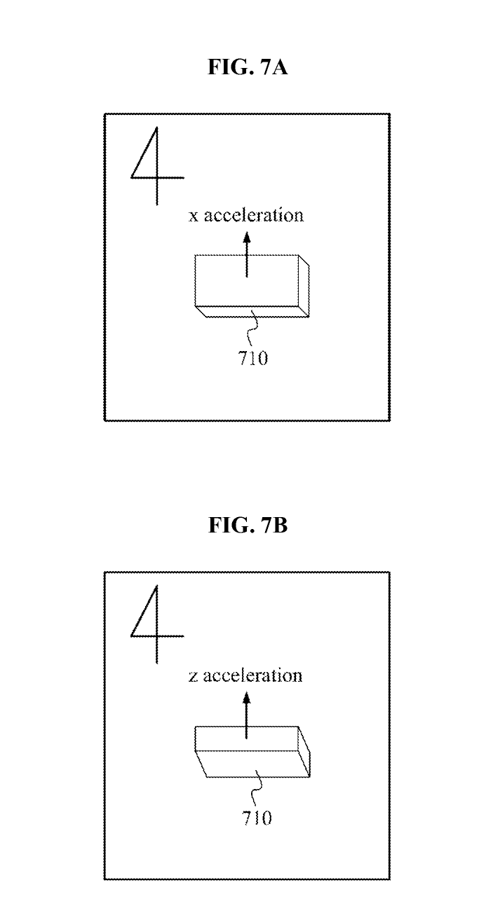

Referring now to FIG. 3, FIG. 4, FIG. 5, FIG. 6A, FIG. 6B, FIG. 7A and FIG. 7B, these figures are diagrams to illustrate operations of a motion recognizing sensor according to exemplary embodiments of the present invention.

Referring to FIG. 3, a motion recognizing sensor 310 may include an acceleration sensor, a gyro sensor, and a terrestrial magnetism sensor. The motion recognizing sensor 310 may be provided to a device, such as to the first device 210 or the second device 220.

The acceleration sensor may measure an acceleration value that acts with respect to each of an x axis, a y axis, and a z axis. The acceleration may be divided into static acceleration and dynamic acceleration. The static acceleration refers to, for example, acceleration of gravity that acts downwards on the earth at all times, and may be distributed to three axes, such as the x axis, the y axis, and the z axis, based on a direction in which the motion recognizing sensor 310 is positioned, and thereby measure the static acceleration, for example. Accordingly, when the acceleration of gravity is estimated based on the acceleration measured on each of the three axes, a direction of the motion recognizing sensor 310 positioned with respect to the ground may be known. And the dynamic acceleration refers to acceleration that is measured when the motion recognizing sensor 310 moves in response to a force actually applied, such as to the first device 210 or to the second device 220, and may be measured by excluding an element of the acceleration of gravity from acceleration sensed on three axes, for example.

As illustrated in FIG. 4, when a vector summation is calculated or determined by utilizing, as a vector value, a dynamic acceleration value sensed on each of the three axes, actual acceleration 401 and a movement direction may be known or determined, for example.

Accordingly, using the acceleration sensor, a device including the motion recognizing sensor 310 may calculate or determine a direction moved into a reference direction during a reference unit time, for example.

Referring now to FIG. 5, parts (a), (b), and (c) of FIG. 5, illustrate graphs to illustrate principles of calculating or determining a movement direction, according to exemplary embodiments of the present invention.

Part (a) of FIG. 5 is a graph illustrating acceleration measured during a reference unit time when a stopped device moves into a reference direction.

Part (b) of FIG. 5 illustrates a graph in which a speed at which the device moves in a corresponding direction is estimated by integrating the acceleration measured in part (a) of FIG. 5.

Part (c) of FIG. 5 illustrates a graph in which a movement distance is estimated by integrating the speed estimated in part (b) of FIG. 5.

As illustrated in parts (a), (b) and (c) of FIG. 5, it is possible to measure the movement distance of the device using the acceleration measured during the reference unit time, for example, according to exemplary embodiments.

A gyro sensor may measure angular velocity with respect to x, y, and z axial rotation of the device, such as the first device 210 or the second device 220. Accordingly, using information sensed by the gyro sensor, it is possible to be aware of information associated with a pitch motion, a roll motion, and a yaw motion of the device, for example.

When the device, such as the first device 210 or the second device 220, for example, is moving into the y axial direction, rotary motion based on the x axis may be defined or determined as a roll motion, rotary motion based on the y axis may be defined or determined as a pitch motion, and rotary motion based on the z axis may be defined or determined as a yaw motion.

When the device, such as the first device 210 or the second device 220, performs a pitch motion, a roll motion, or a yaw motion, the acceleration sensor may measure an acceleration value by a rotary motion of the device and an acceleration value by a translation motion of the device, for example. Accordingly, when information associated with the rotary motion of the device is known, it is possible to correct an acceleration value measured per time unit, based on acceleration occurring due to the rotary motion. The device may estimate the acceleration value of the translation motion based on the corrected acceleration value.

A terrestrial magnetism sensor may measure a magnetic field of the earth. The magnetic field of the earth typically maintains a constant or relatively constant direction. Therefore, when the magnetic field of the earth is measured, an absolute direction, for example, the bearings of the device, such as the first device 210 or the second device 220, may be estimated.

When the bearings of the device are known, it is possible to estimate a movement direction and a movement distance of the device based on the bearings by combining a direction and an acceleration value of the device estimated to be positioned using the acceleration sensor and the gyro sensor, and rotary angular velocity information, for example.

Referring now to FIGS. 6A and 6B, and FIGS. 7A and 7B, these figures illustrate bearings moved along a motion of a device, according to exemplary embodiments of the present invention.

A device 610 may measure an acceleration value of an x axial direction using an acceleration sensor, and may be aware of bearings information using a terrestrial magnetism sensor, for example. Using the acceleration sensor and a terrestrial magnetism sensor, the device 610 may determine whether the device 610 has moved in the east direction as illustrated in FIG. 6A or whether the device 610 has moved in the north direction as illustrated in FIG. 6B.

Also, when the device 610 moves in the north direction as illustrated in FIGS. 7A and 7B, the device 610 may measure the bearings into which the device 610 has actually moved using the terrestrial magnetism sensor, regardless of a direction in which the device 610 is positioned, for example.

As described above with reference to FIG. 3 through FIG. 7B, a device may measure the bearings and a movement distance per reference unit time by combining sensing information that is measured from an acceleration sensor, a gyro sensor, and a terrestrial magnetism sensor. For example, the device may estimate and correct a positional change amount per unit time using the acceleration sensor, the gyro sensor, and the terrestrial magnetism sensor, according to exemplary embodiments.

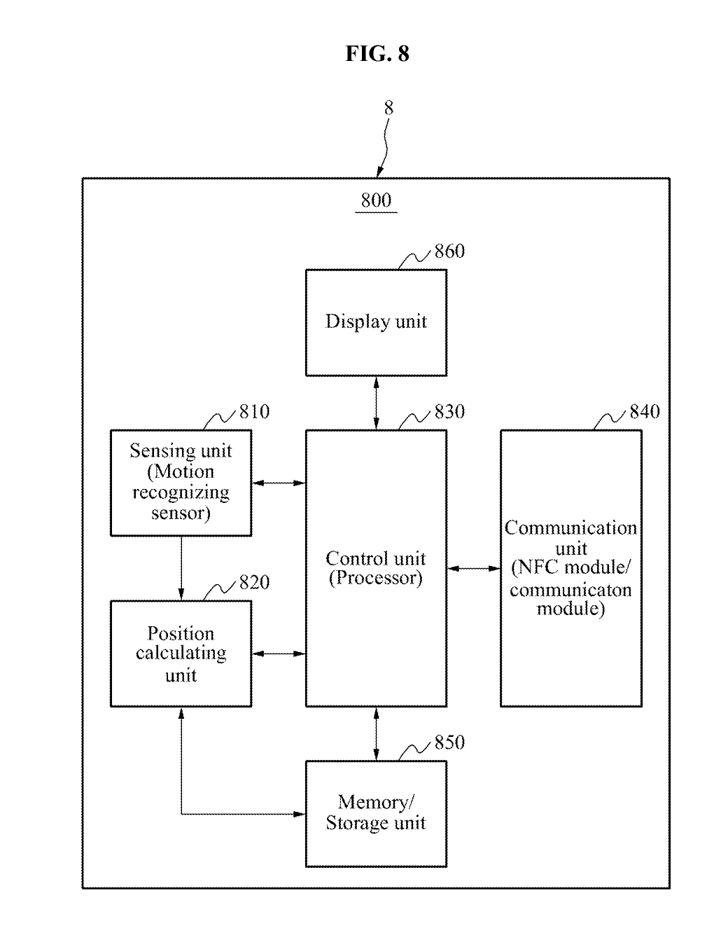

FIG. 8 is a block diagram illustrating a configuration of an apparatus for position detection and communication according to exemplary embodiments of the present invention.

Referring to FIG. 8, the apparatus 800, such as a terminal 8, for position detection and communication may be a device described above with reference to FIG. 1 through FIG. 7B, and may also be referred to as the apparatus 800. A host device and a corresponding device described throughout the specification herein may include a configuration of the apparatus 800 of the terminal 8 of FIG. 8, for example, but should not be construed in a limiting sense. The apparatus 800, such as a terminal, may be a portable terminal, for example, a smart phone, a table PC, and a notebook, or other apparatuses, for example, and should also not be construed in a limiting sense.

Continuing with reference to FIG. 8, the apparatus 800, such as a terminal 8, may include a sensing unit 810, a position calculating unit 820, a control unit 830, a communication unit 840, a memory/storage unit 850, and a display unit 860, for example.

The sensing unit 810 may sense a motion of the apparatus 800, such as of the terminal 8, and may calculate or determine a positional change amount from a starting position of the apparatus 800, such as the terminal 8.

The sensing unit 810 may include a motion recognizing sensor. The sensing unit 810 may measure the positional change amount based on a sensing value of the motion recognizing sensor. The sensing unit 810 may measure the positional change amount from the starting position according to the principles described with reference to FIG. 1 through FIG. 7B.

The position calculating unit 820 may calculate the starting position based on the measured positional change amount. For example, the position calculating unit 820 may calculate or determine a current position L(a, b, c) based on an origin L(0) by considering a movement direction and a movement distance of a device, such as the terminal 8.

The control unit 830 may set the starting position through connection with a corresponding device, such as another terminal, or a server device, for example, and may update the current position of the terminal 8. The control unit 830 may include at least one processor.

The control unit 830, such as configured as a processor, may perform an overall control of the apparatus 800 and the terminal 8, such as to control operations for performing position detection and communication of the apparatus 800 and of the terminal 8 of FIG. 8. In this regard, the control unit 830 may also perform operations of the sensing unit 810, the position calculating unit 820, the communication unit 840, the memory/storage unit 850, and the display unit 860, as well as may control or perform other operations of the terminal 8. In the exemplary embodiments of the apparatus 800 of the terminal 8 of FIG. 8, the configurations of the described units have been illustrated separately in order to describe each operation individually. Accordingly, in the apparatus 800 of the terminal 8 all of the configurations or operations of the described units may be designed to be processed by the control unit 830, and, alternatively, only a portion of the configurations or operations of the described units may be designed to be processed by the control unit 830, according to exemplary embodiments.

The terminal 8 and the apparatus 800 including the control unit 830, the sensing unit 810, the position calculating unit 820, the communication unit 840, the memory/storage unit 850, and the display unit 860 associated with and may include any of various memory or storage media for storing software, program instructions, data files, data structures, and the like, and are associated with and may also include any of various processors, computers or application specific integrated circuits (ASICs) for example, to implement various operations performing position detection and communication of the terminal apparatus 800 of the terminal 8 of FIG. 8, as described herein.

And although the apparatus 800 of the terminal 8 including the control unit 830, the sensing unit 810, the position calculating unit 820, the communication unit 840, the memory/storage unit 850, and the display unit 860, and the herein described units, processors, memories, modules, elements, devices or components of the terminal 8 and apparatus 800 may be described as separate units, processors, memories, modules, elements, devices or components, aspects are not limited thereto such that each of units, processors, memories, modules, elements, devices or components may be combined with any one or more units, processors, memories, modules, elements, devices or components, for example, and should therefore should not be construed in a limiting sense.

Also, the software, media and program instructions as may be included in or used by the apparatus 800 of the terminal 8 including the control unit 830, the sensing unit 810, the position calculating unit 820, the communication unit 840, the memory/storage unit 850, and the display unit 860, may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described exemplary embodiments of the present invention.

Continuing with reference the apparatus 800 of the terminal 8 of FIG. 8, the starting position may be a position physically identical to a starting position of the corresponding device or a starting position of the server device. Also, a reference error may be allowed with respect to the physically identical or substantially identical position.

The control unit 830 may trigger a starting position setting operation in a state in which the apparatus 800 of the terminal 8 is positioned at the position physically identical or substantially identical to a position of the corresponding device or the server device. The starting position setting operation may be initiated in a state in which the apparatus 800 of the terminal 8 is positioned at the position physically identical or substantially identical to the position of the corresponding device or the server device. Triggering of the starting position setting operation will be further described with reference to FIG. 12.

When a pre-registered position sharing group of the apparatus 800 corresponding to a host device is absent or not present and a pre-registered position sharing group of the corresponding device is also absent, or not present, the control unit 830 may perform a process of setting, as the starting position, the position physically identical or substantially identical to the starting position of the corresponding terminal or the starting position of the server device, for example.

When the pre-registered position sharing group of the apparatus 800 of the terminal 8 is absent, or not present, and the pre-registered position sharing group of the corresponding device is present, the control unit 830 may set the starting position of the corresponding device as the starting position of the apparatus 800 of the terminal 8, and may set a current position of the corresponding device as a current position of the apparatus 800, for example.

When the pre-registered position sharing group of the apparatus 800 of the terminal 8 is present and the pre-registered position sharing group of the corresponding device is absent, or not present, the control unit 830 may add the corresponding device to pre-registered position sharing group information.

When a pre-registered first position sharing group of the apparatus 800 of the terminal 8 is present and a pre-registered second position sharing group of the corresponding device is present, the control unit 830 may set the current position as a new starting position, for example.

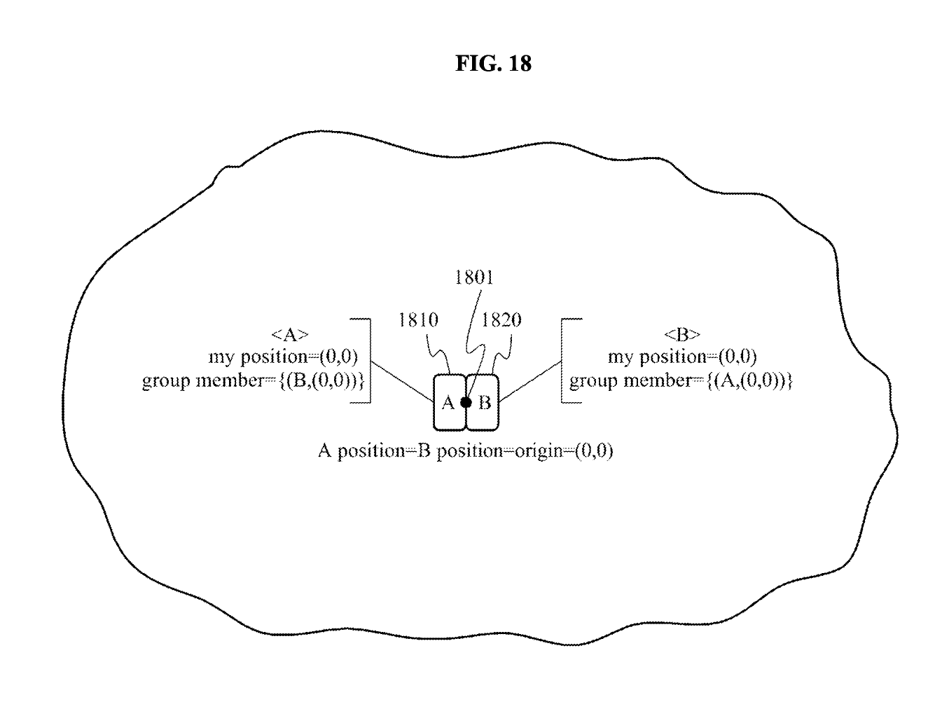

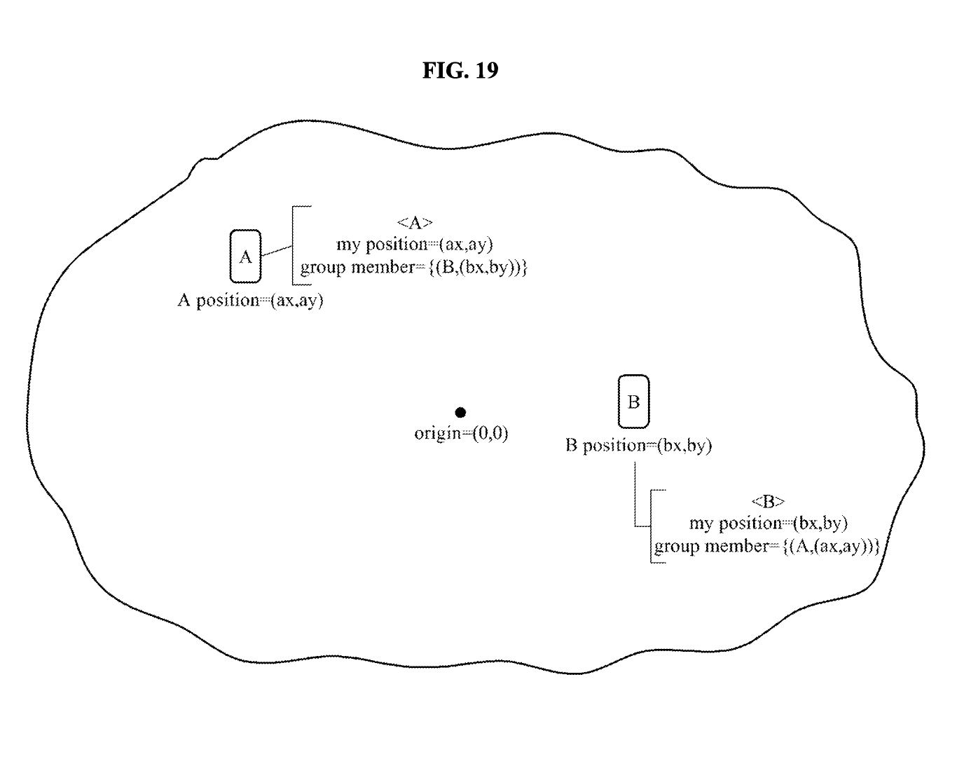

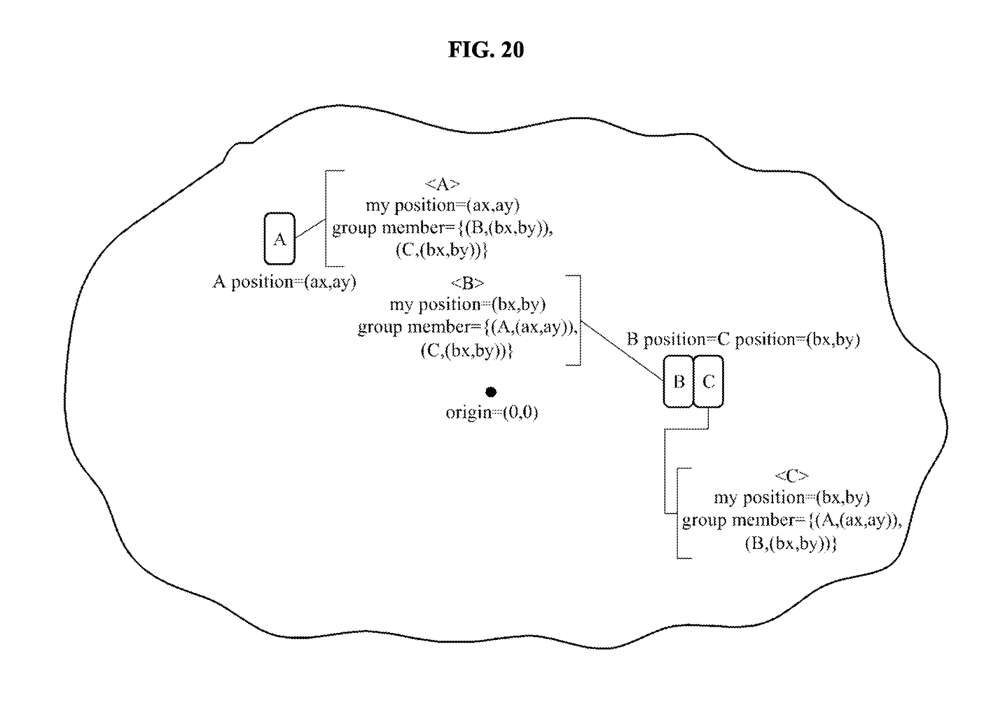

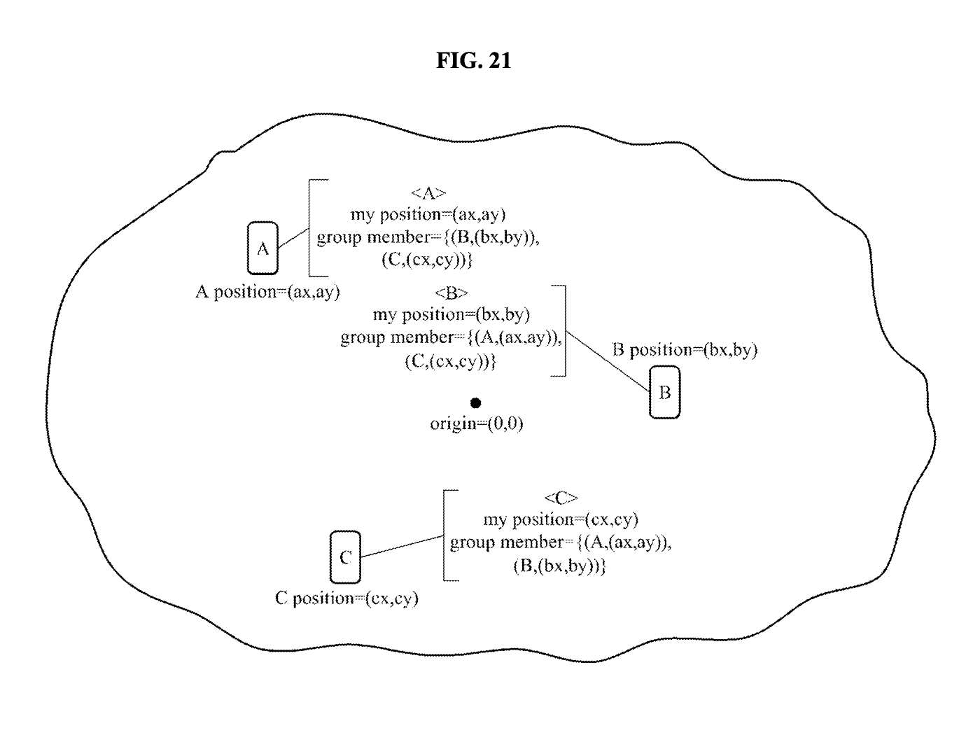

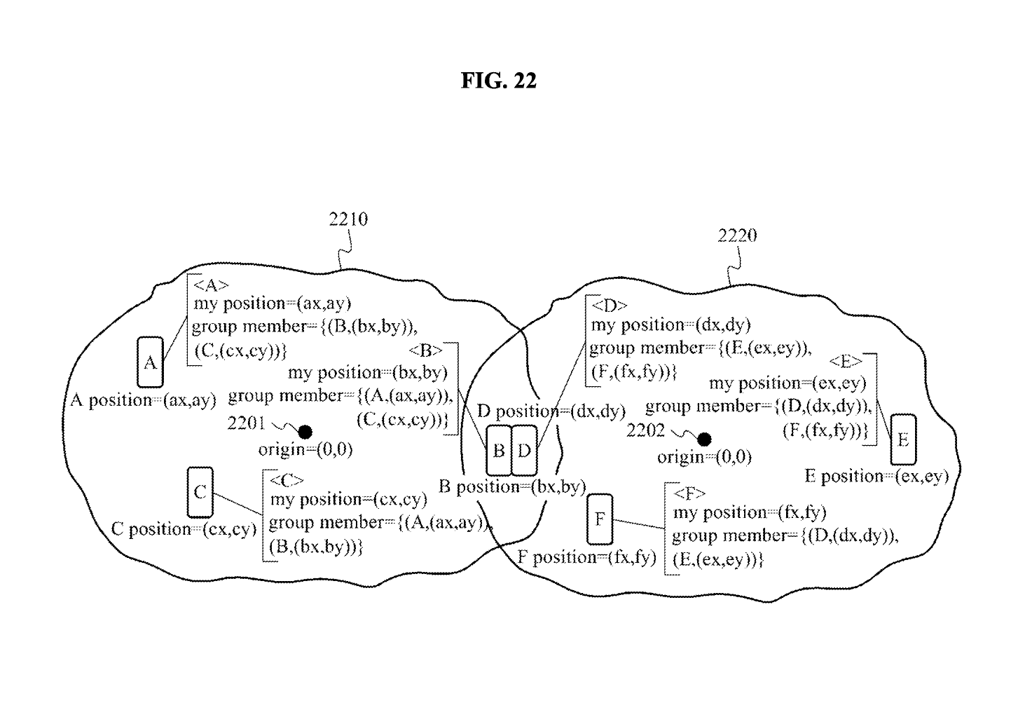

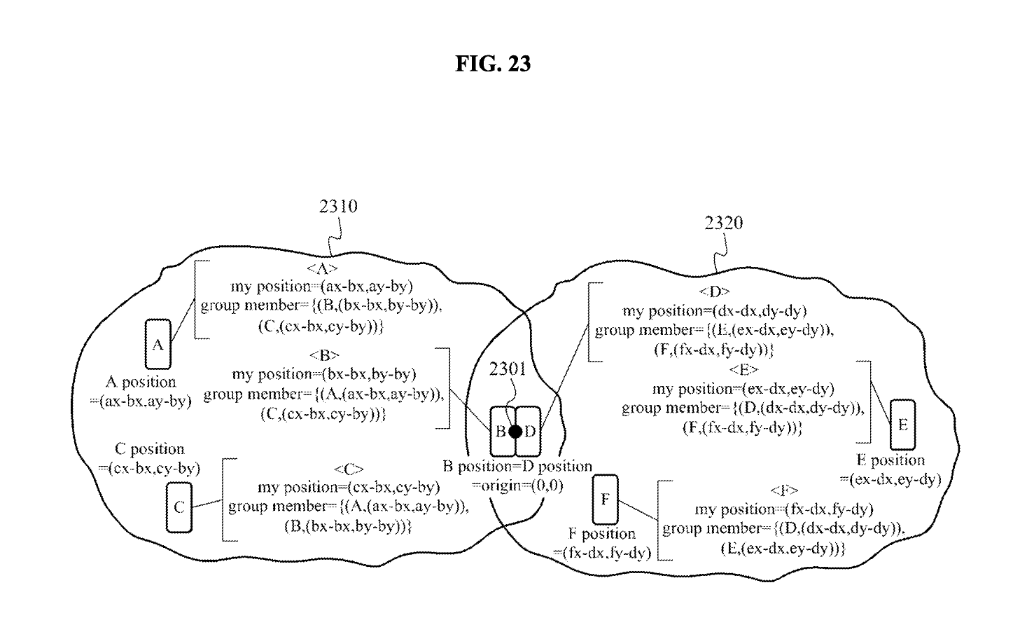

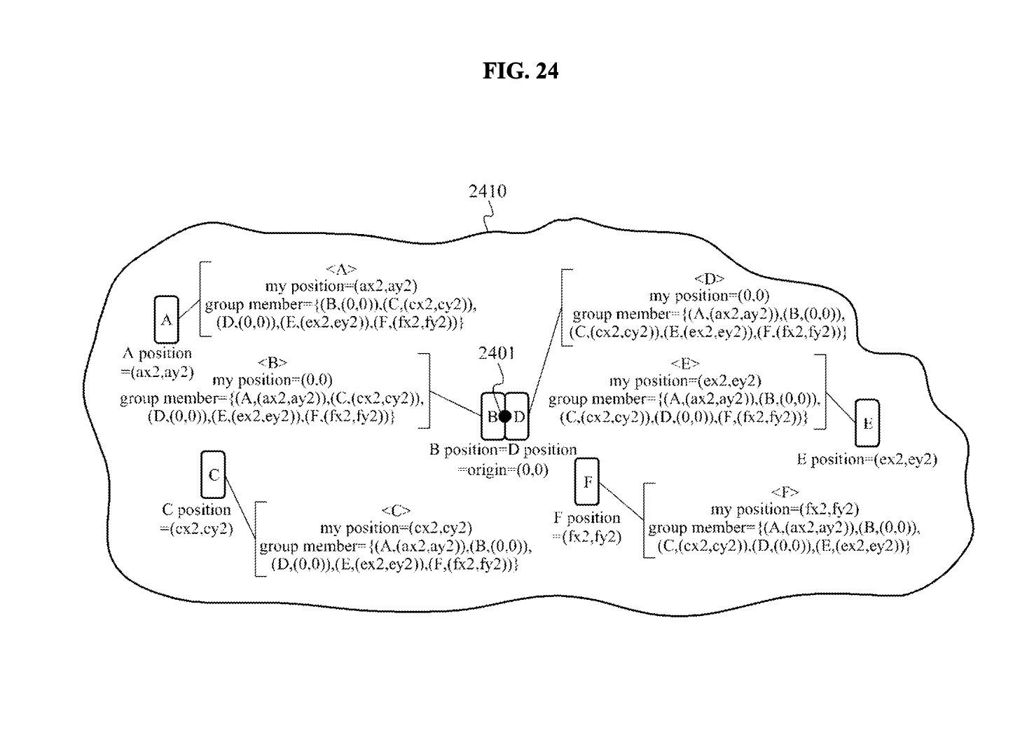

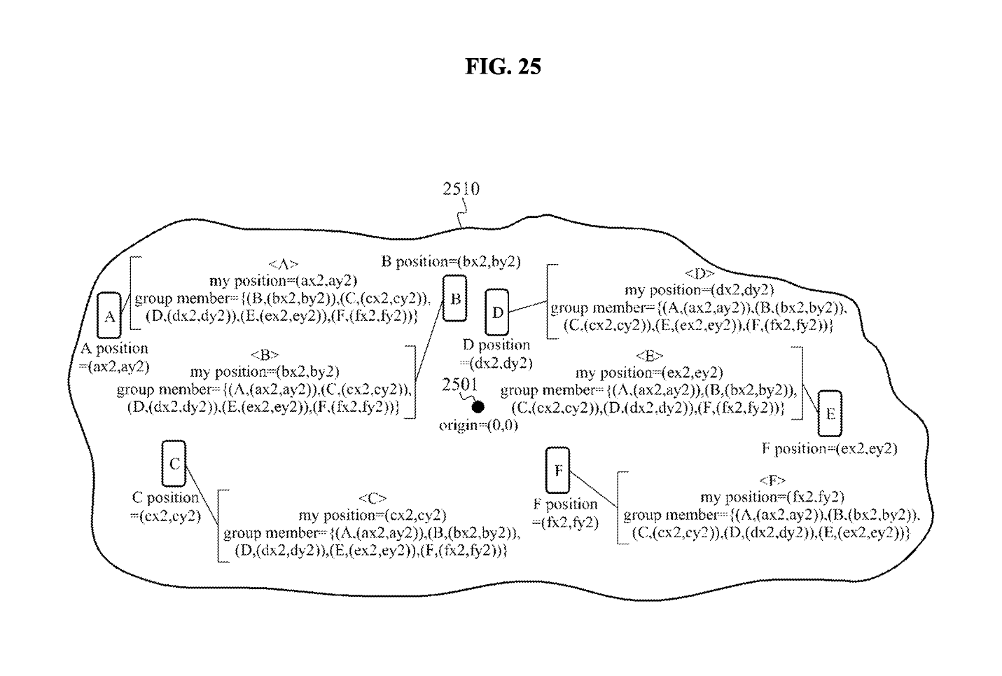

The “position sharing group” may indicate a set of devices, such a set of apparatuses 800 of terminals 8, of which position information is mutually verified in order to perform communication. The position sharing group will be further described with reference to FIG. 18 through FIG. 29.

When a starting position update event occurs, the control unit 830 may change the starting position and may correct current position information of the apparatus 800 of the terminal 8 based on the changed starting position.

The control unit 830 may set a position sharing group including the apparatus 800 of the terminal 8. When a current position update event of the apparatus 800 of the terminal 8 or a current position update event of a member belonging to the position sharing group occurs, the control unit 830 may update information associated with the position sharing group, for example.

The “current position update event of the apparatus 800” may occur when the current position of the host device is separate from the starting position or a previously calculated or determined position by at least a reference distance, at reference time intervals, or in response to an input instruction, for example.

In this regard, for example, the control unit 830 may update the current position of the apparatus 800 of the terminal 8 when a change in a position of the apparatus 800 of the terminal 8 occurs by at least a reference distance compared to a previous position of the apparatus 800 of the terminal 8, may update the current position of the apparatus 800 of the terminal 8 at reference time intervals, or may receive an instruction from a user of the apparatus 800 of the terminal 8 and thereby update the current position of the apparatus 800 of the terminal 8.

The control unit 830 may continuously or relatively continuously check whether the current position update event occurs while the position sharing group including the apparatus 800 of the terminal 8 is being maintained.

The communication unit 840 may broadcast the updated current position in response to control of the control unit 830, for example, according to exemplary embodiments.

The communication unit 840 may receive, from the corresponding device or the server device, i.e. an external device to the terminal 8, information associated with the current position of the corresponding device that is calculated or determined based on the starting position. The control unit 830 may store information associated with the current position of the corresponding device in the memory/storage unit 850.

The communication unit 840 may receive a broadcast message from each of members, such as external devices or other terminals, belonging to the position sharing group. The control unit 830 may perform adding of a position sharing member, deleting of the position sharing member, updating of a current position of the position sharing member, merging of group information, or changing of the starting position based on a type of the broadcast message, for example.

Also, when a message is received in a message standby state, the communication unit 840 may perform processing according to each message and return to the message standby state.

Further, when a position sharing message is received, the control unit 830 may update position information of a group member of which a position is updated. When a group information update message is received, the control unit 830 may merge group information stored in a device, such as a terminal, with received group information. When a device delete message is received, the control unit 830 may delete communication information and position information associated with the device from group information stored in a device of the control unit 830. When an origin change message is received, the control unit 830 may correct the position of the apparatus 800 of the terminal 8, e.g. a host device user's position (“my position’), compared to the received origin and also correct a stored position of a group member, for example.

The starting position setting operation of the apparatus 800 of the terminal 8, executed under the control of the control unit 830, may be triggered by accessing an external device through NFC, or other suitable communication, to access or obtain information, such as position information, from the external device, for example. The communication unit 840 may include an NFC module, for example, or other suitable communication module in this regard to communicate with the external device, such as another terminal, for example.

The memory/storage unit 850 may store position information of the corresponding device and position information of the apparatus 800, and may store communication information of the corresponding device and the like. The memory/storage unit 850 may also store data, applications or programs for operations of the terminal 8 and for operations of the apparatus 800 for performing position detection and communication of the terminal 8, according to exemplary embodiments.

The display unit 860 may display a current position of each of the members belonging to the position sharing group using a variety of schemes. The display unit 860 may include a touch screen. The display unit 860 may receive a user input through the touch screen of the apparatus 800 of the terminal 8, for example.

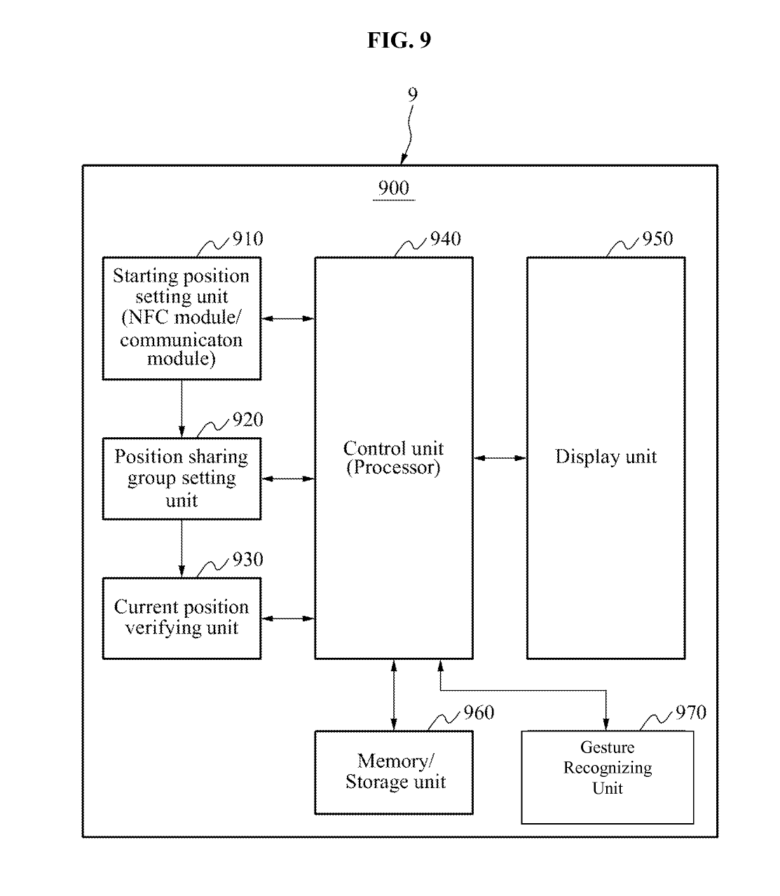

FIG. 9 is a block diagram illustrating a configuration of an apparatus for position detection and communication according to exemplary embodiments of the present invention.

An apparatus 900 of a terminal 9 for position detection and communication may be a device described above with reference to FIG. 1 through FIG. 7, and may also be referred to as the apparatus 900, for example. Also, a host device and a corresponding device described throughout the specification herein may include a configuration of the apparatus 900 or the terminal 9 of FIG. 9, for example, but should not be construed in a limiting sense and may also include a configuration of the apparatus 800 of the terminal 8 of FIG. 8 or include all or one or more of the units thereof, for example.

Referring to FIG. 9, the apparatus 900 of the terminal 9 may include a starting position setting unit 910, a position sharing group setting unit 920, a current position verifying unit 930, a control unit 940, a display unit 950, a memory/storage unit 960 and a gesture recognizing unit 970. Even though not illustrated in FIG. 9, the apparatus 900 of the terminal 9 may further include a configuration identical to or similar to the sensing unit 810 of FIG. 8 to perform the same or similar operations to those of the sensing unit 810 described with respect to the apparatus 800 of the terminal 8 of FIG. 8, for example. Also, the apparatus 900 of the terminal 9 may include all or one or more of the described units of the apparatus 800 of the terminal 8. And, likewise, the apparatus 800 of the terminal 8 may include all or one or more of the described units of the apparatus 900 of the terminal 9, for example, according to exemplary embodiments.

The control unit 940, such as configured as a processor, as may perform an overall control of the apparatus 900 and the terminal 9, such as to control operations for performing position detection and communication of the apparatus 900 and of the terminal 9 of FIG. 9. In this regard, the control unit 940 may also perform operations of the starting position setting unit 910, the position sharing group setting unit 920, the current position verifying unit 930, the display unit 950, a memory/storage unit 960 and a gesture recognizing unit 970, as well as may control or perform other operations of the terminal 9. In the exemplary embodiments of the apparatus 900 of the terminal 9 of FIG. 9, the configurations of the described units have been illustrated separately in order to describe each operation individually. Accordingly, in the apparatus 900 of the terminal 9 all of the configurations or operations of the described units may be designed to be processed by the control unit 940, and, alternatively, only a portion of the configurations or operations of the described units may be designed to be processed by the control unit 940, according to exemplary embodiments.

Likewise the apparatus 900 of the terminal 9 of FIG. 9 including the starting position setting unit 910, the position sharing group setting unit 920, the current position verifying unit 930, the control unit 940, the display unit 950, the memory/storage unit 960 and the gesture recognizing unit 970 are associated with and may include any of various memory or storage media for storing software, program instructions, data files, data structures, and the like, and are associated with and may also include any of various processors, computers or application specific integrated circuits (ASICs) for example, to implement various operations for performing position detection and communication of the terminal apparatus 900 of the terminal 9 of FIG. 9, as described herein.

And although the terminal 9 and the apparatus 900 including the starting position setting unit 910, the position sharing group setting unit 920, the current position verifying unit 930, the control unit 940, the display unit 950, the memory/storage unit 960 and the gesture recognizing unit 970, and the herein described units, processors, memories, modules, elements, devices or components of the terminal 9 and the apparatus 900 may be described as separate units, processors, memories, modules, elements, devices or components, aspects are not limited thereto such that each of units, processors, memories, modules, elements, devices or components may be combined with any one or more units, processors, memories, modules, elements, devices or components, for example, and should therefore should not be construed in a limiting sense.

Also, the software, media and program instructions as may be included in or used by the terminal 9 and the apparatus 900 including the starting position setting unit 910, the position sharing group setting unit 920, the current position verifying unit 930, the control unit 940, the display unit 950, the memory/storage unit 960 and the gesture recognizing unit 970, may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described exemplary embodiments of the present invention.

The starting position setting unit 910 may set a starting position of the apparatus 900 of the terminal 9 through connection or communication with a corresponding device, such as an external device to the terminal 9, or a server device associated with a position sharing group. The starting position setting unit 910 may set, as an origin of a coordinate system, a position at which a starting position setting operation is triggered or based, for example.

The starting position setting operation may be triggered by accessing an external device through NFC or other suitable communication. The starting position setting unit 910 may include an NFC module or other suitable communication module. For example, the starting position setting unit 910 may include the NFC module to execute the starting position setting operation when the apparatus 900 of the terminal 9 is connected to the external device through the NFC. For example, when the apparatus 900 of the terminal 9 is connected to the external device through the NFC in a state in which a position detection algorithm is executed, the starting position setting operation may be automatically executed.

The position sharing group setting unit 920 may set or determine a position sharing group including the apparatus 900 of the terminal 9 and the at least one corresponding device. The position sharing group setting unit 920 may generate information associated with devices that share a current position, and may store the generated information, for example.

The current position verifying unit 930 may verify or determine a current position of each of members such as one or more devices, as, for example, one or more terminals, such as including the terminal 9 and one or more other terminals, belonging to the position sharing group based on a coordinate system using the starting position as an origin of the coordinate system. The current position of each of the members or devices belonging to the position sharing group may be received from each of the members or devices.

The current position verifying unit 930 may measure or determine a positional change amount from the starting position of the apparatus 900 of the terminal 9, may calculate or determine a current position of the apparatus 900 of the terminal 9 based on the positional change amount, may receive, from the at least one corresponding device or the server device, information associated with a current position of the at least one corresponding device that is calculated or determined based on the starting position, and may update information associated with the current position of the at least one corresponding device, for example.

The control unit 940 may perform the same or similar operations as the control unit 830 of FIG. 8, or may control the overall operation of the apparatus 900 of the terminal 9, for example, as described. In this regard, the control unit 940 controls setting of or sets a starting position of the terminal, such as the terminal 9, and controls updating the current position of the terminal, and controls performing position detection and communication of the terminal, for example.

In response to a user input to the apparatus 900 of the terminal 9, the control unit 940 may perform an operation of selecting a reference member or device from a position sharing group to transmit or receive content or an operation of supporting transmission or reception of content. The user input may be input using a reference gesture. The apparatus 900 may further include the gesture recognizing unit 970 to recognize a gesture, and also recognize a type of gesture, of a user such as on a screen of the display unit 950. The gesture may include at least one of touch, drag, and flicking, for example. The gesture recognition by the gesture recognizing unit 970 may also include user motion recognition, such as through a sensor or a camera of the terminal 9 associated with the gesture recognizing unit 970 of the apparatus 900, for example.

The memory/storage unit 960 may also store data, applications or programs for operations of the terminal 9 and for operations of the apparatus 900 for performing position detection and communication of the terminal 9, according to exemplary embodiments.

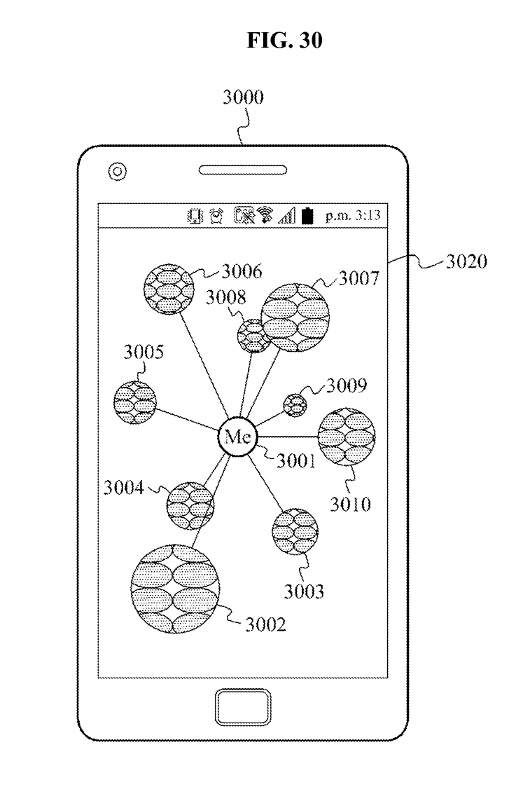

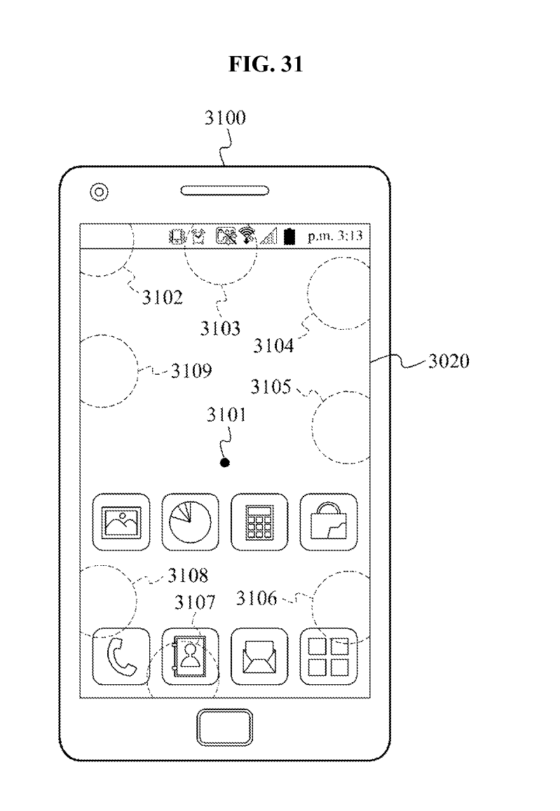

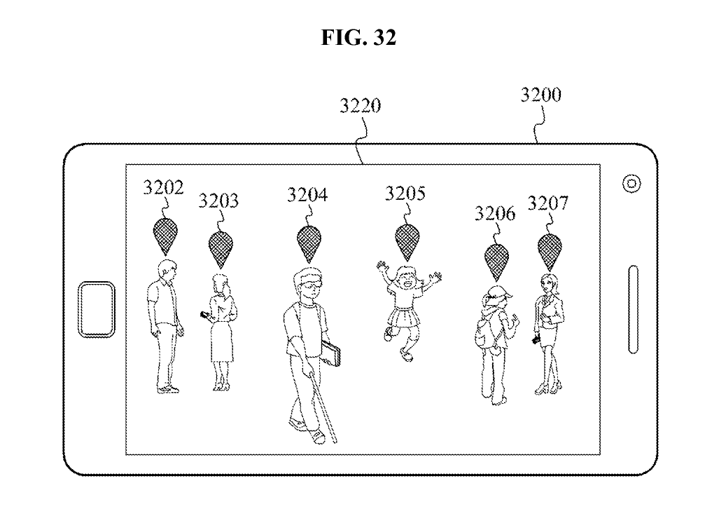

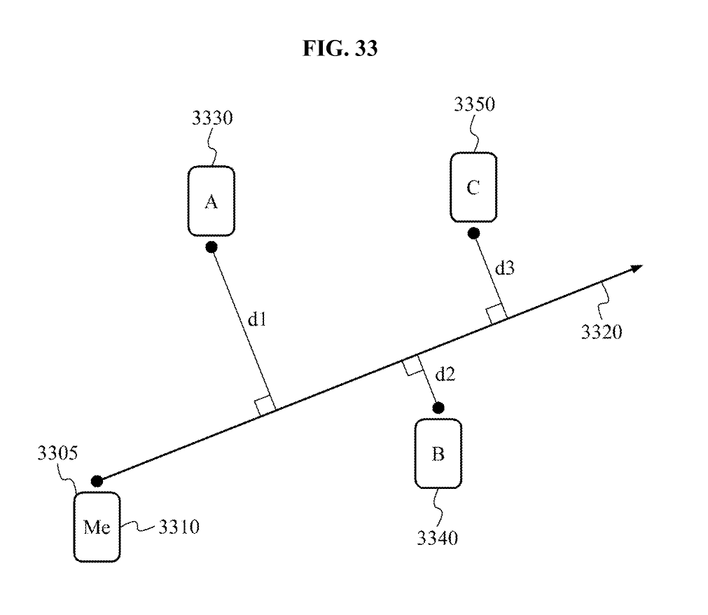

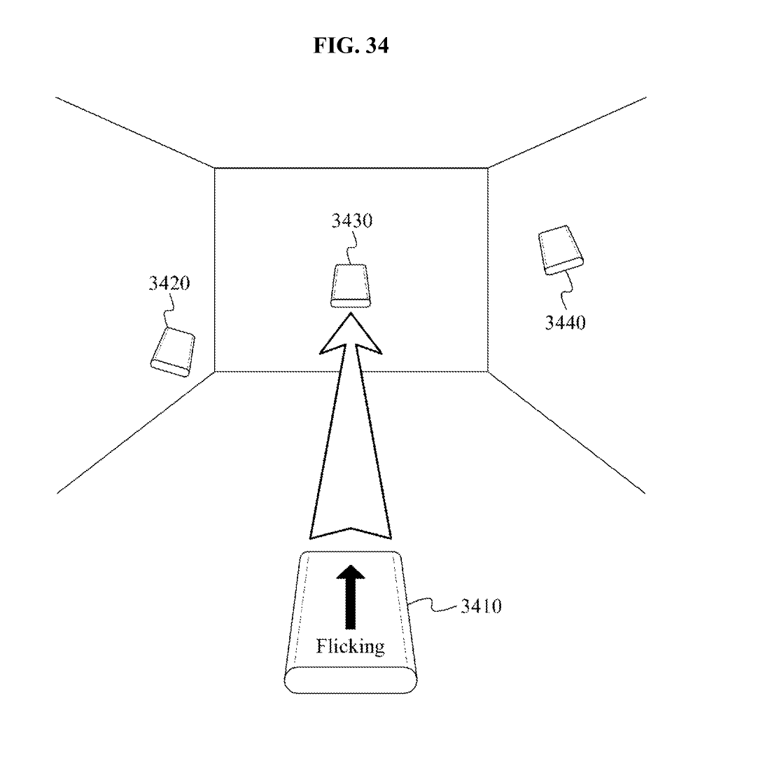

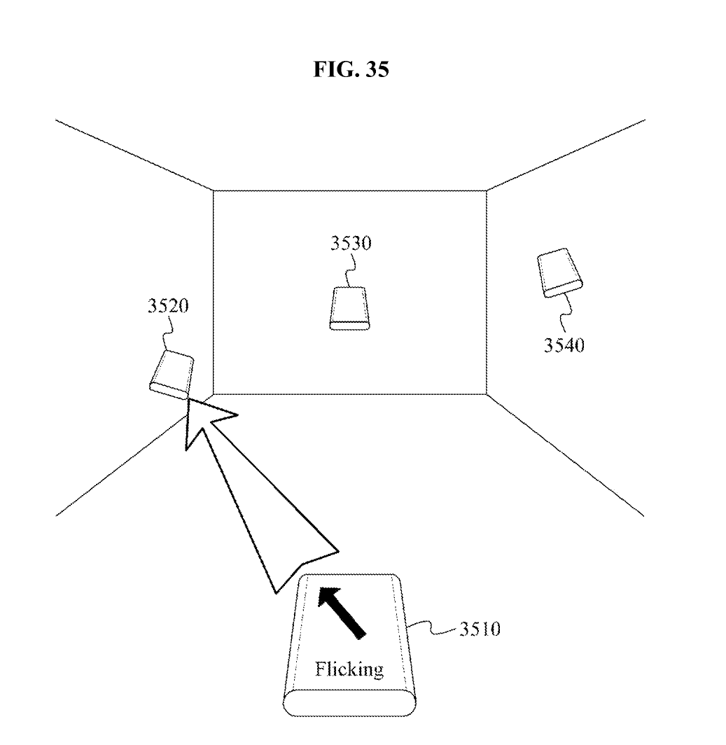

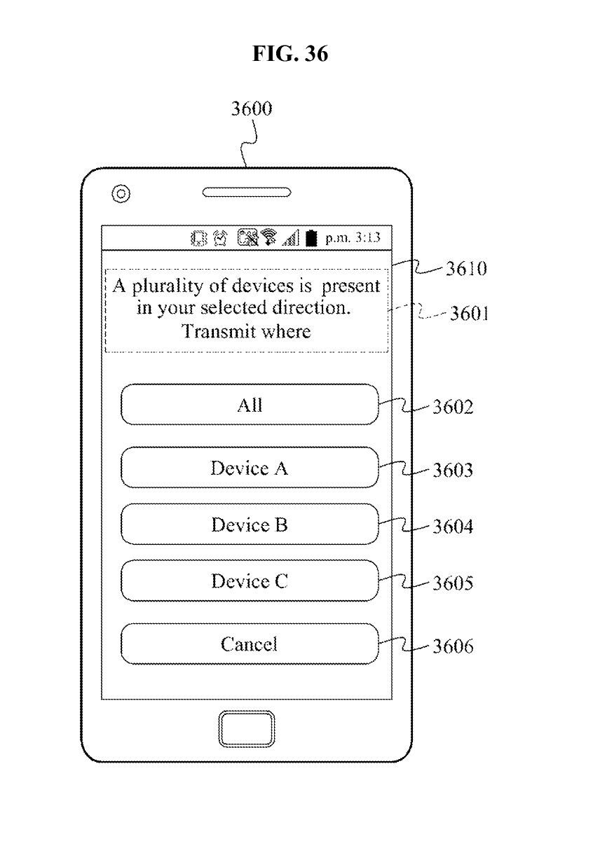

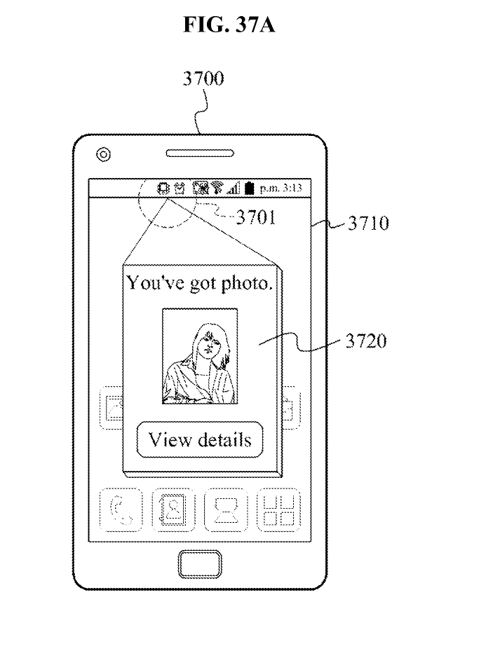

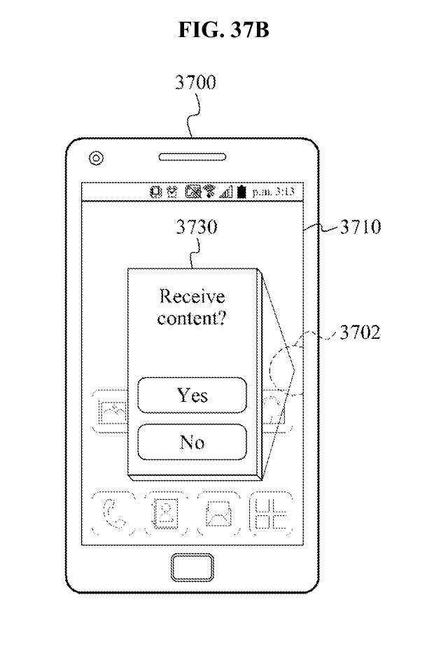

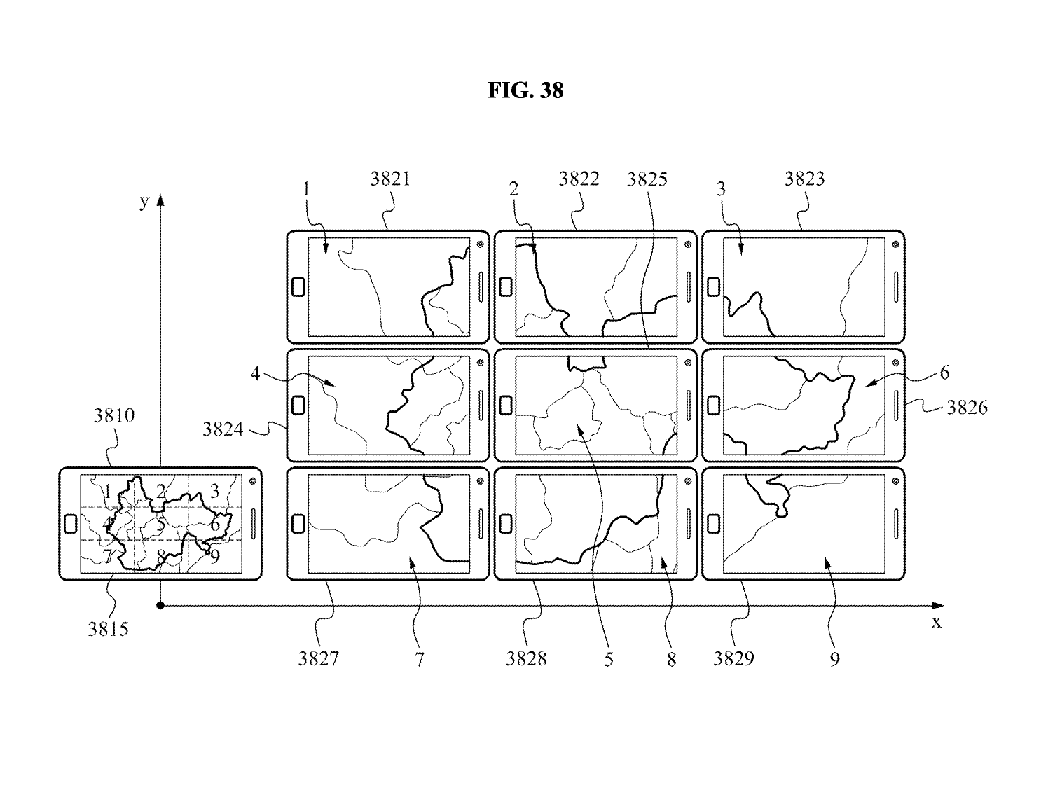

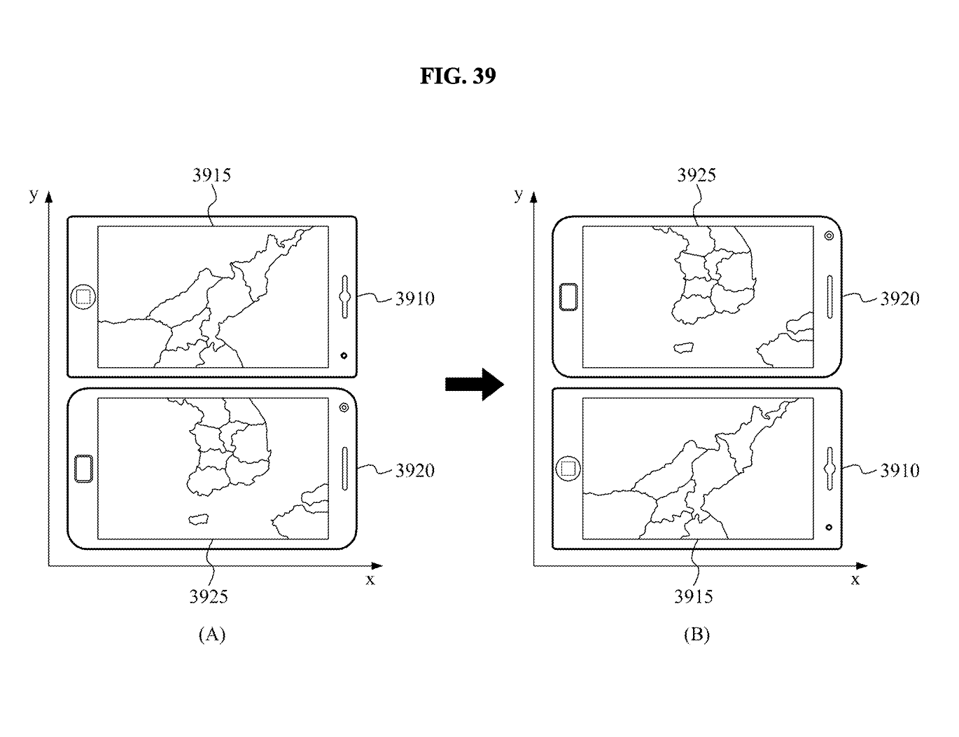

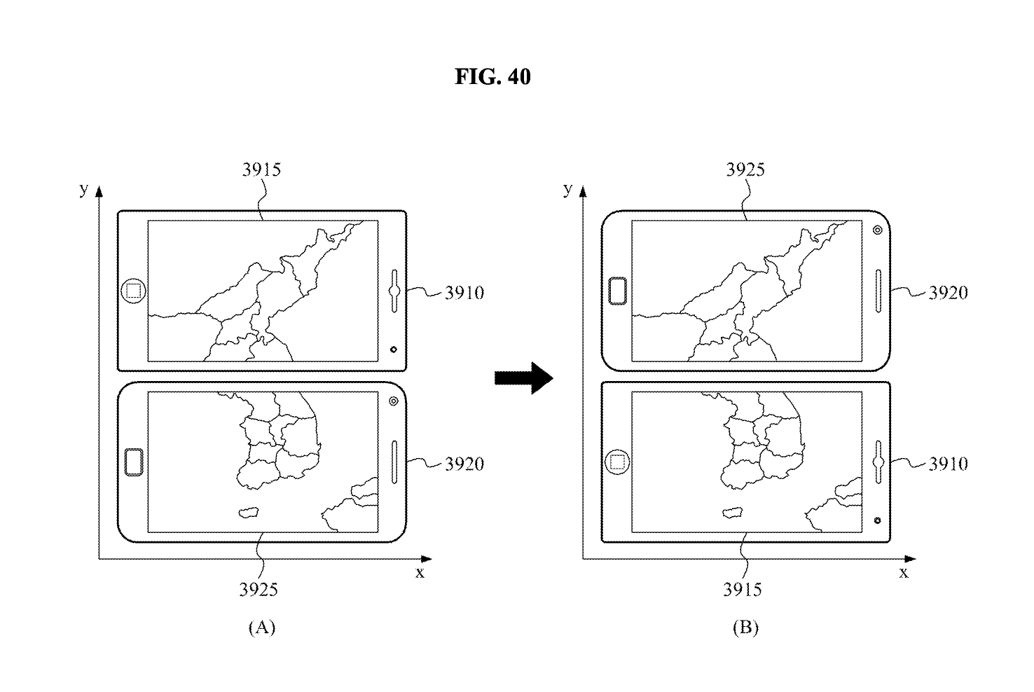

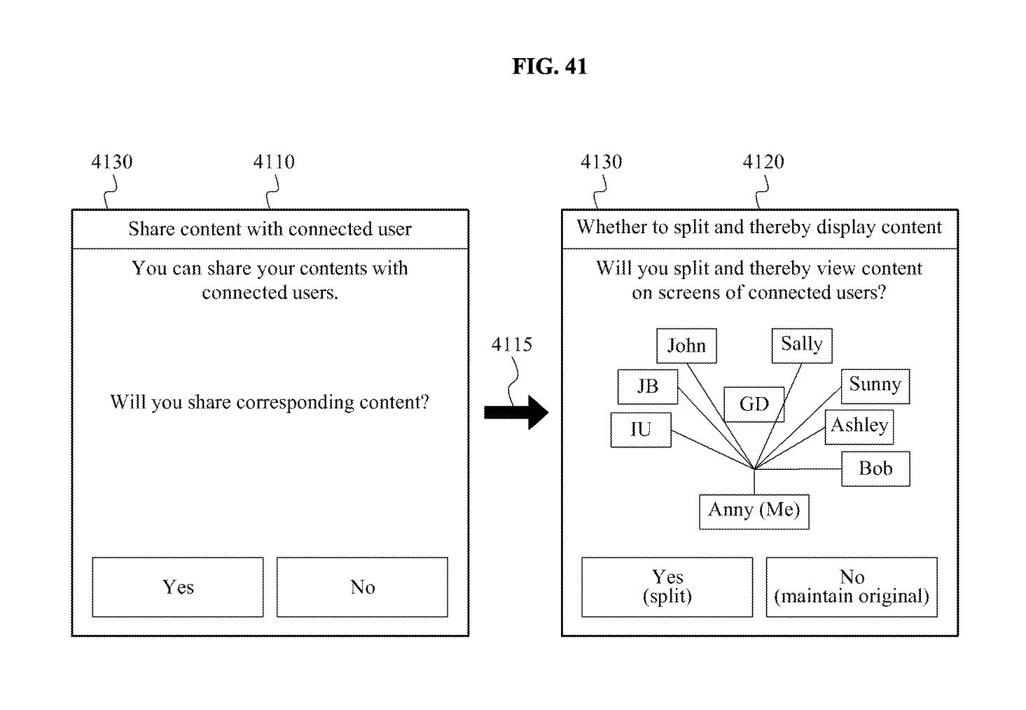

The display unit 950 may display a current position of each of members or devices, such as, for example, one or more terminals, that belong to the position sharing group. Methods for displaying a current position of each of the members or devices belonging to the position sharing group will be described with reference to FIG. 30 through FIG. 32, according to exemplary embodiments.

The display unit 950 may display a portion of an original image or a portion of an original motion picture on a screen of the display unit 950 based on the current position of each of the members or devices. Displaying a portion of an original image will be described with reference to FIG. 38 through 40, for example, according to exemplary embodiments.

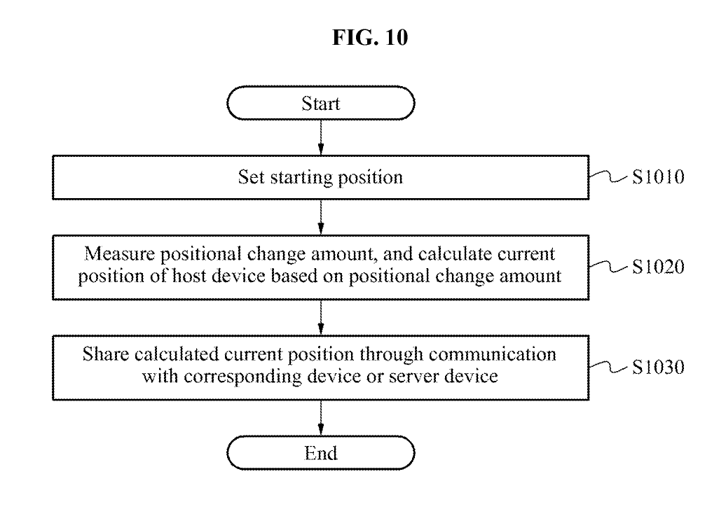

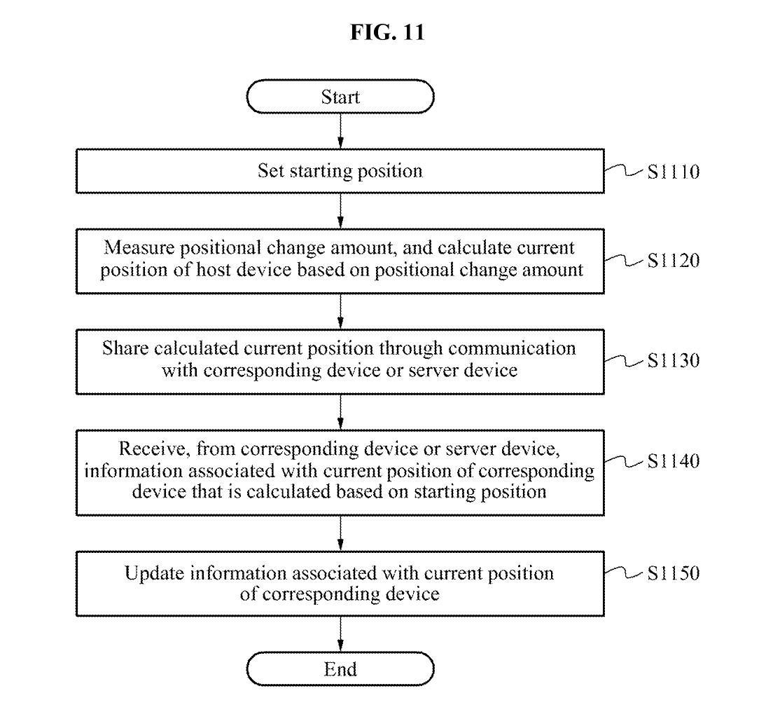

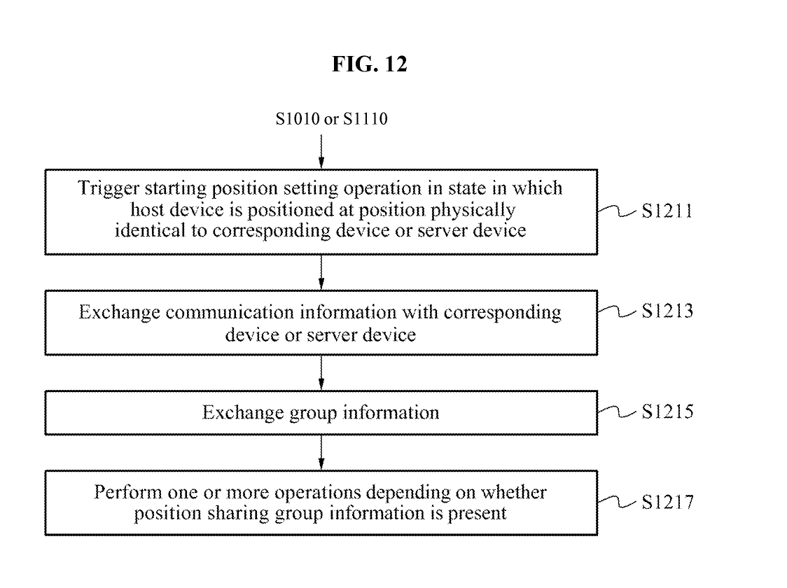

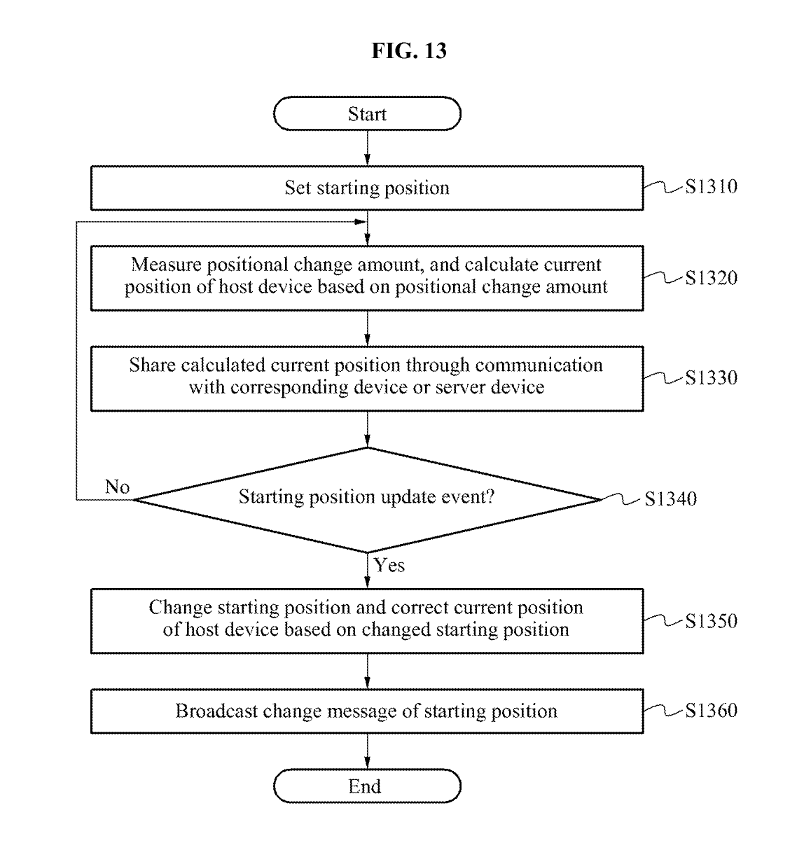

FIG. 10, FIG. 11, FIG. 12 and FIG. 13 are flowcharts illustrating methods for position detection and communication performed at a host device according to exemplary embodiments of the present invention.

The methods for position detection and communication may generally include an access process, a position detecting process, a broadcast receiving process, and an origin updating process, for example, according to exemplary embodiments.

After passing through the access process that is a process for setting a starting position while exchanging communication information between devices, the devices may belong to a single position sharing group. A device may continuously, relatively continuously, periodically or randomly, for example, update a position of the device through the position detecting process and may share position information of the device with other devices. The broadcast receiving process for position detection and communication may be separately performed, for example. In this regard, position information received from another device may be updated, or group change information or origin update may be processed. The origin updating process is a process that is performed when an origin is to be updated in a reference circumstance or based on a reference criterion or criteria, for example.

Continuing with reference to FIG. 10, in operation S1010, a host device may set a starting position of a device, such as the apparatus 800 of the terminal 8 or the apparatus 900 of the terminal 9, through connection or communication with a corresponding device or a server device. The starting position set in operation S1010 may be a position physically identical or substantially identical to a starting position of the corresponding device or the server device.

Operation S1010 may include operations S1211 through S1217 of FIG. 12, for example.

In operation S1020, the host device, such as the apparatus 800 of the terminal 8 or the apparatus 900 of the terminal 9, may measure a positional change amount from the starting position, and may calculate or determine a current position of the host device based on the positional change amount.

In operation S1030, the host device, such as the apparatus 800 of the terminal 8 or the apparatus 900 of the terminal 9, may share the calculated or determined current position through communication with the corresponding device or the server device.

Referring now to FIG. 11, operations S1110 through S1130 of FIG. 11 may be identical or substantially identical to operations S1010 through S1030 of FIG. 10 and, therefore, a further detailed description of operations S1110 through S1130 will be omitted and reference is made to the description herein of operations S1010 through S1030 of FIG. 10 in this regard.

Continuing with operation S1140 in FIG. 11, in operation S1140, the host device, such as the apparatus 800 of the terminal 8 or the apparatus 900 of the terminal 9, may receive, from the corresponding device or the server device, information associated with a current position of the corresponding device that is calculated or determined based on the starting position. For example, the host device may receive information associated with the current position of the corresponding device directly from the corresponding device or from the server device, for example.

In operation S1150, the host device, such as the apparatus 800 of the terminal 8 or the apparatus 900 of the terminal 9, may update information associated with the current position of the corresponding device. When information associated with the current position of the corresponding device is initially received, the host device may store the current position of the corresponding device, for example. Also, when pre-stored current position information of the corresponding device is present, the host device may update the pre-stored current position information of the corresponding device, for example.

FIG. 12 is a flowchart illustrating methods for setting a starting position according to exemplary embodiments of the present invention.

In relation to the operations of FIG. 12, a reference operation may be performed to set an identical or substantially identical starting position between devices, such as the apparatus 800 of the terminal 8 or the apparatus 900 of the terminal 9.

Also, in this regard, as illustrated in FIG. 2, a user may position the first device 210 and the second device 220 at the physically identical position L(0), and may trigger a starting position setting operation. A control unit, such as the control unit 830 of FIG. 8 or the control unit 940 of FIG. 9, of the first device 210 may initiate an operation of activating a motion recognizing sensor or calculating or determining a positional change amount. The starting position setting operation may be initiated using one or more methods, for example.

For example, the starting position setting operation may be automatically triggered when a reference button provided on the first device 210 is manipulated or when communication is initiated between devices through NFC, or other suitable communication, for example.

Also, the starting position setting operation may be triggered by recognizing a dedicated apparatus installed in a reference place or reference location, Radio-frequency identification (RFID), or a quick response (QR) code, for example. The dedicated apparatus installed in the reference place or reference location may be a server device. When the server device includes an NFC operation, the starting position setting operation may be triggered through the NFC. When the server device is fixed in the reference place or reference location, a position of the server device may be an origin of a coordinate system, for example. The server device may register devices, such as the apparatus 800 of the terminal 8 or the apparatus 900 of the terminal 9, and manage a registration list of one or more devices, for example.

Referring again to FIG. 12, in operation S1211, the host device, such as the apparatus 800 of the terminal 8 or the apparatus 900 of the terminal 9, may trigger the starting position setting operation in a state in which the host device is positioned at a position physically identical or substantially identical to a position of the corresponding device or the server device. When a reference error range is allowed, the host device may trigger the starting position setting operation at a position separate from the corresponding device or the server device, such as by a few centimeters, or other relatively small distance, for example.

In operation S1213, the host device, such as the apparatus 800 of the terminal 8 or the apparatus 900 of the terminal 9, may exchange communication information with the corresponding device or the server device. The communication information may include one or more parameters used to transmit and receive data, for example. The communication information may be diversified based on a communication network used. For example, when Wi-Fi is used, communication may be performed by exchanging access Internet protocol (IP) information of the respective devices. The communication information may include information associated with a type of a communication protocol used, a time duration used for transmission and reception, address information, a network access ID, and the like, for example.

In operation S1215, the host device, such as the apparatus 800 of the terminal 8 or the apparatus 900 of the terminal 9, may exchange group information with the corresponding device or the server device. The group information may include information associated with a position sharing group, for example.

Information associated with the position sharing group may include, for example, information associated with an identifier for identifying the position sharing group, communication information of each of members or devices that belong to the position sharing group, and a current position of each of the members or devices that belong to the position sharing group.

Also, when registered group information is absent or not present, group information exchanged in operation S1215 may indicate that a registered group is absent or not present, for example.

In operation S1217, the host device, such as the apparatus 800 of the terminal 8 or the apparatus 900 of the terminal 9, may perform one or more operations, such as, for example, one or more of the following four operations depending on whether position sharing group information of each of the host device, such as the apparatus 800 of the terminal 8 or the apparatus 900 of the terminal 9, and the corresponding device is present.

Initially, when the host device, such as the apparatus 800 of the terminal 8 or the apparatus 900 of the terminal 9, and the corresponding device do not have a registered position sharing group, a first operation may be performed, for example, according to exemplary embodiments.

When a registered sharing position group of the host device is absent or not present and a registered position sharing group of the corresponding device is absent or not present, the host device, such as the apparatus 800 of the terminal 8 or the apparatus 900 of the terminal 9, may set the physically identical or substantially identical position as the starting position.

The first operation may include generating information associated with a new position sharing group including communication information, such as including current position information of one or more devices, such as terminals, and determining to form and forming the new position sharing group of the devices based on the current position information, and sharing the generated information associated with the new position sharing group with the at least one corresponding device or the server device, for example, associated with the new position sharing group.

Also, when the registered sharing position group of the host device, such as the apparatus 800 of the terminal 8 or the apparatus 900 of the terminal 9, is absent or not present and the registered position sharing group of the corresponding device is present, a second operation may be performed, for example, according to exemplary embodiments.

In the second operation, when the registered sharing position group of the host device, such as the apparatus 800 of the terminal 8 or the apparatus 900 of the terminal 9, is absent or not present and the registered position sharing group of the corresponding device is present, the host device may set a starting position of the corresponding device as a starting position of the host device and may set a current position of the corresponding device as a current position of the host device, for example, according to exemplary embodiments.

For example, the host device performing the second operation may be a device C of FIG. 20.

In the above example, the second operation may include adding the host device to position sharing group information that is received from the corresponding device, according to exemplary embodiments.

Further, for example, when the registered sharing position group of the host device, such as the apparatus 800 of the terminal 8 or the apparatus 900 of the terminal 9, is present and the registered position sharing group of the corresponding device is absent or not present, a third operation may be performed, according to exemplary embodiments.

In the third operation, when the registered sharing position group of the host device is present and the registered position sharing group of the corresponding device is absent or not present, the host device, such as the apparatus 800 of the terminal 8 or the apparatus 900 of the terminal 9, may add the corresponding device to the pre-registered position sharing group information, for example.

The third operation may include broadcasting updated position sharing group information to the pre-registered position sharing group of the host device, such as the apparatus 800 of the terminal 8 or the apparatus 900 of the terminal 9. For example, the host device may notify existing members or devices of a new member or device added and position information of the new member or device and communication information.

Also, for example, when a pre-registered first position sharing group of the host device, such as the apparatus 800 of the terminal 8 or the apparatus 900 of the terminal 9, is present and a pre-registered second position sharing group of the corresponding device is present, a fourth operation may be performed, according to exemplary embodiments.

In the fourth operation, when the pre-registered first position sharing group of the host device, such as the apparatus 800 of the terminal 8 or the apparatus 900 of the terminal 9, is present and the pre-registered second position sharing group of the corresponding device is present, the host device may set the current position as a new starting position, for example. The starting position may be a position in a state in which the host device and the corresponding device are positioned at the physically identical or substantially identical position. The starting position described herein may be used as a new origin of the coordinate system, for example.

The fourth operation may include updating a position of a group member or device within the first position sharing group based on the new starting position, for example.

The fourth operation may further include an operation of generating information associated with a new position sharing group based on information associated with the first position sharing group and information associated with the second position sharing group, such as including current position information of one or more devices, such as terminals, and sharing information associated with the new position sharing group with members or devices belonging to the first position sharing group and the second position sharing group, for example according to exemplary embodiments.

FIG. 13 is a flowchart illustrating methods for position detection and communication according to exemplary embodiments of the present invention.

Operations S1310 through S1330 of FIG. 13 may be identical or substantially identical to operations S1010 through S1030 of FIG. 10 and, therefore, a further detailed description of operations S1310 through S1330 of FIG. 13 will be omitted and reference is made to the description herein of operations S1010 through S1030 of FIG. 10 in this regard.

Therefore, continuing with reference to FIG. 13, in operation S1340, the host device, such as the apparatus 800 of the terminal 8 or the apparatus 900 of the terminal 9, may determine whether a starting position update event occurs, for example.

When the starting position update event occurs, the host device, such as the apparatus 800 of the terminal 8 or the apparatus 900 of the terminal 9, may change the starting position and correct the current position of the host device based on the changed starting position in operation S1350. However, when the starting position update event does not occur, the process returns to operation S1320.

In operation S1360, the host device, such as the apparatus 800 of the terminal 8 or the apparatus 900 of the terminal 9, may broadcast a change message of the starting position to the position sharing group including the host device and the corresponding device, for example.

The starting position update event to change or update the starting position may occur or may be initiated, for example, in the case of merging position sharing groups as described above in the fourth operation of operation S1217 of FIG. 12. Also, the starting position update event may occur when current positions of all of the members or devices belonging to the position sharing group are separate from the origin by at least a reference distance, or when a reference number of members or devices are currently positioned from the origin by at a reference distance, for example. Also, updating of the starting position may be initiated through broadcasting of an origin update message of at least one of the members or devices.

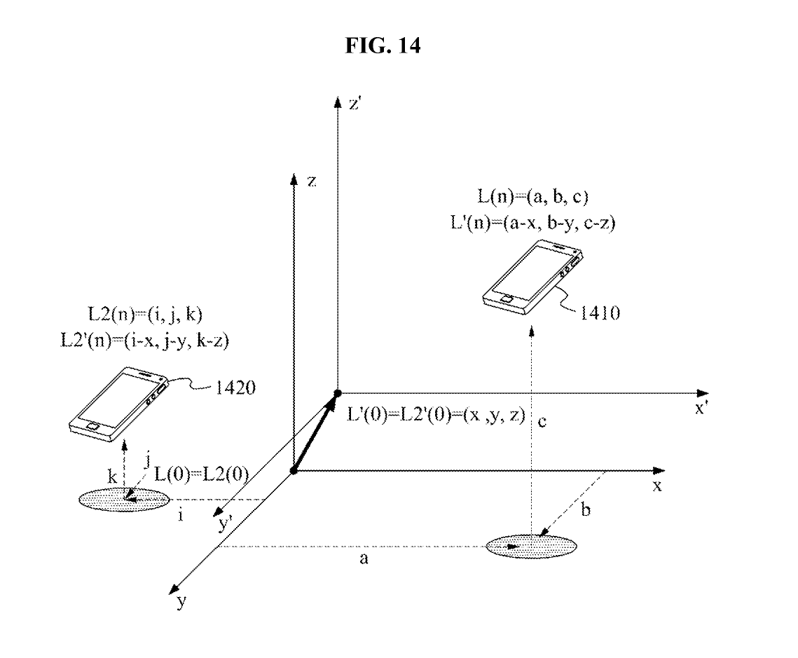

FIG. 14 is a diagram to illustrate concepts of origin correction according to exemplary embodiments of the present invention.

For example, updating of a starting position may indicate correcting or updating of an origin of a coordinate system.

In this regard, when at least two position sharing groups are merged, an origin may need to be updated. In addition, the origin may be updated when a position of the origin is significantly or substantially deviated from centers of devices, when a plurality of devices are moving in a single direction compared to or with reference to the origin, while adding or deleting a plurality of devices, and the like, for example.

When updating of the origin is initiated, a device, such as the apparatus 800 of the terminal 8 or the apparatus 900 of the terminal 9, may correct a position of the device, for example, e.g. a host device user's position (“my position”), and a stored position of a group member or device based on the changed origin. The device may broadcast an origin change message so that other group members or devices may also update the origin, for example.

As illustrated in FIG. 14, when an origin is changed from L(0)=(0, 0, 0) to L′(0)=(x, y, z), coordinate axes may be moved into the respective axial directions by x, y, and z. Accordingly, a reference position, for example, a point L(n)=(a, b, c) of an existing coordinate system may be expressed as L′(n)=(a-x, b-y, c-z) in a new coordinate system.

For example, L(0), L(n), and L2(n) of the existing coordinate system may be changed L′(0), L′(n), and L2′(n) in the new coordinate system as expressed by Equation 3.

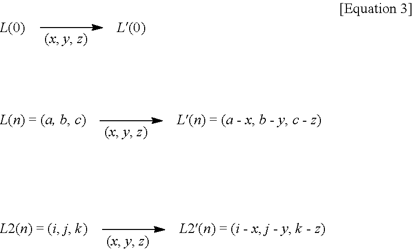

Using Equation 3, the devices, such as the apparatus 800 of the terminal 8 or the apparatus 900 of the terminal 9, may correct current position information and position information of members or devices within the position sharing group based on the new origin (x, y, z), for example, according to exemplary embodiments.

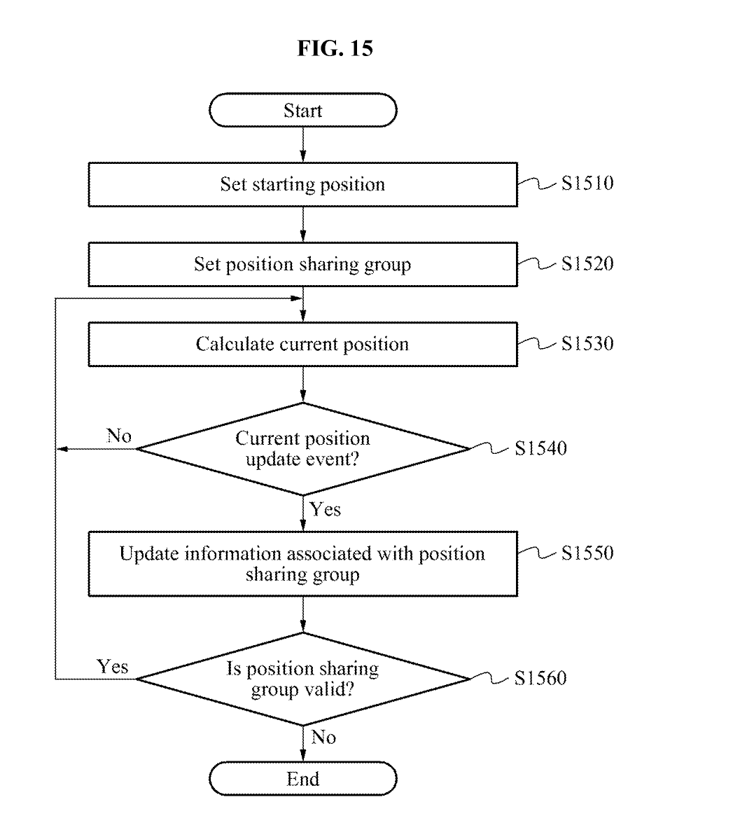

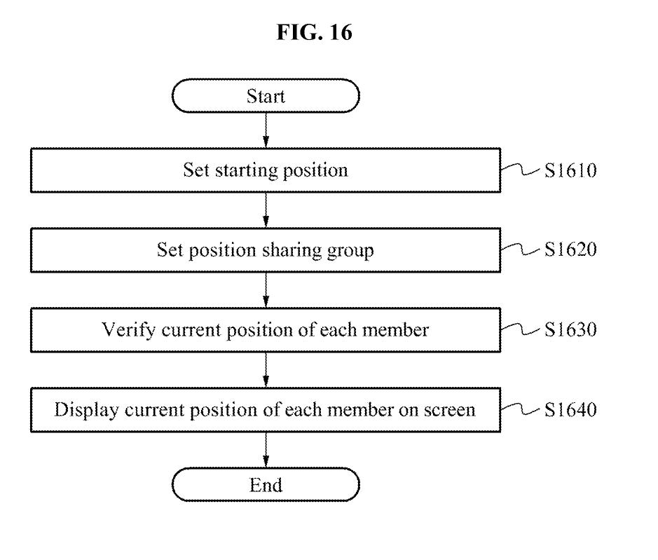

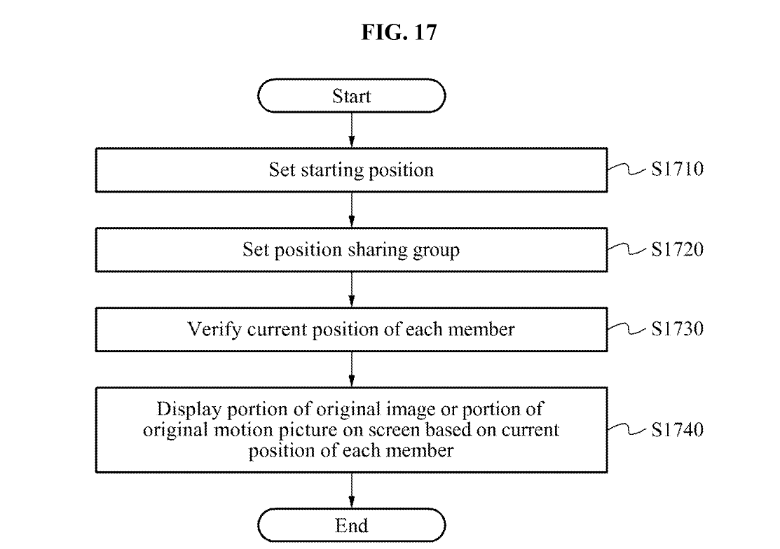

FIG. 15, FIG. 16 and FIG. 17 are flowcharts illustrating methods for position detection and communication performed at a host device according to exemplary embodiments of the present invention.

Referring to FIG. 15, in operation S1510, a host device, such as the apparatus 800 of the terminal 8 or the apparatus 900 of the terminal 9, may set a starting position through connection with a corresponding device or a server device, for example.

In operation S1520, the host device, such as the apparatus 800 of the terminal 8 or the apparatus 900 of the terminal 9, may set a position sharing group including the host device and the corresponding device.

In operation S1530, the host device, such as the apparatus 800 of the terminal 8 or the apparatus 900 of the terminal 9, may measure or determine a positional change amount from the starting position, and may calculate or determine a current position of the host device based on the positional change amount, for example.

In operation S1540, the host device, such as the apparatus 800 of the terminal 8 or the apparatus 900 of the terminal 9, may determine whether a current position update event occurs. The current position update event may include, for example, a current position update event of the host device and a current position update event of a member or device of the position sharing group. When the current position update event occurs the process proceeds to operation S1550. And, if the current position update event is not determined to have occurred, the process returns to operation S1530.

In operation S1550, when the current position update event of the host device, such as the apparatus 800 of the terminal 8 or the apparatus 900 of the terminal 9, or current position update event of a member or device of the position sharing group occurs, the host device may update information associated with the position sharing group, for example. The host device may update position information of a member or device of which position information is changed.

The current position update event of the host device, such as the apparatus 800 of the terminal 8 or the apparatus 900 of the terminal 9, may occur when the current position of the host device is separate from the starting position or a previously calculated or determined position by at least a reference distance, at reference time intervals, or in response to an input instruction, such as from a user of the device, such as the host device, for example.

The current position update event of the member or device of the position sharing group may occur in response to a received message. For example, when the host device, such as the apparatus 800 of the terminal 8 or the apparatus 900 of the terminal 9, receives a broadcast message from a member or device of the position sharing group and the received broadcast message includes updated position information of a reference member or reference device, the host device may update information associated with the position sharing group.

The methods for position detection and communication may further include operation S1560 of FIG. 15, according to exemplary embodiments.

In operation S1560, the host device, such as the apparatus 800 of the terminal 8 or the apparatus 900 of the terminal 9, may determine whether the position sharing group is valid. For example, when no member or device is present in the position sharing group, or when a user of a device terminates sharing of a position, the position sharing group may become invalid.

When the position sharing group is determined to be valid at operation S1560, for example, such as when the position sharing group is maintained, the process returns to operation S1530 and operations S1530 through S1550 may be iteratively performed, for example, according to exemplary embodiments. When the position sharing group is determined not to be valid at operation S1560, the process proceeds to End.

In this regard, a device may receive a broadcast message from a member or device of the position sharing group, and may perform adding of a position sharing member or device, deleting of the position sharing member or device, updating of a current position of the position sharing member or device, merging of group information, or changing of the starting position based on a type of the broadcast message, for example, according to exemplary embodiments.

Also, the device, such as the apparatus 800 of the terminal 8 or the apparatus 900 of the terminal 9, may independently perform an operation of calculating or determining a current position and a process of performing communication. Therefore, an operation of processing information based on the type of the broadcast message may be performed after one of operations S1530 through S1550 is performed, for example, according to exemplary embodiments.

Referring now to FIG. 16, in operation S1610, a device, such as the apparatus 800 of the terminal 8 or the apparatus 900 of the terminal 9, may set a starting position through connection with a corresponding device or a server device.

In operation S1620, the device, such as the apparatus 800 of the terminal 8 or the apparatus 900 of the terminal 9, may set a position sharing group including the host device and the corresponding device.

In operation S1630, the device, such as the apparatus 800 of the terminal 8 or the apparatus 900 of the terminal 9, may verify, measure, or determine a current position of each of members or devices belonging to the position sharing group, based on a coordinate system using the starting position as an origin, for example.

Also, in operation S1630, the host device, such as the apparatus 800 of the terminal 8 or the apparatus 900 of the terminal 9, may measure or determine a positional change amount from the starting position, and may calculate or determine a current position of the host device based on the positional change amount.

Also, in operation S1630, the host device, such as the apparatus 800 of the terminal 8 or the apparatus 900 of the terminal 9, may receive, from the corresponding device or the server device, information associated with the current position of the corresponding device that is calculated or determined based on the starting position, and may update information associated with the current position of the corresponding device, for example.

In operation S1640, the device, such as the apparatus 800 of the terminal 8 or the apparatus 900 of the terminal 9, may display, on a screen, such as a screen of the display unit 860 of the apparatus 800 of the terminal 8 or a screen of the display unit 950 of the apparatus 900 of the terminal 9, the current position of each of the members or devices belonging to the position sharing group. In this regard, methods for displaying a current position of each of the members or devices belonging to a position sharing group will be described with reference to FIG. 30 through FIG. 32, for example according to exemplary embodiments.

Referring now to FIG. 17, in operation S1710, a host device, such as the apparatus 800 of the terminal 8 or the apparatus 900 of the terminal 9, may set a starting position through connection with a corresponding device or a server device.

In operation S1720, the host device, such as the apparatus 800 of the terminal 8 or the apparatus 900 of the terminal 9, may set a position sharing group including the host device and the corresponding device.

In operation S1730, the host device, such as the apparatus 800 of the terminal 8 or the apparatus 900 of the terminal 9, may verify, measure, or determine a current position of each of members or devices belonging to the position sharing group, based on a coordinate system using the starting position as an origin, for example.

In operation S1740, the host device, such as the apparatus 800 of the terminal 8 or the apparatus 900 of the terminal 9, may display on a screen, such as on a screen of the display unit 860 of the apparatus 800 of the terminal 8 or on a screen of the display unit 950 of the apparatus 900 of the terminal 9, a portion of an original image or a portion of an original motion picture based on the current position of each of the members or devices, for example, according to exemplary embodiments.

FIG. 18, FIG. 19, FIG. 20, FIG. 21, FIG. 22. FIG. 23. FIG. 24 and FIG. 25 are diagrams to illustrate operations for generating a position sharing group and detecting a position according to exemplary embodiments of the present invention.

Even though the exemplary embodiments of FIG. 18 through FIG. 25 are described based on a two-dimensional (2D) coordinate system for ease of description, the exemplary embodiments are not limited to the 2D coordinate system and may be readily expanded to a three-dimensional (3D) coordinate system, for example, according to exemplary embodiments.

FIG. 18 illustrates a diagram in which a plurality of devices generates a position sharing group according to exemplary embodiments of the present invention.

Continuing with reference to FIG. 18, each of the device A 1810 (hereinafter, device A) and the device B 1820 (hereinafter, device B) may execute a starting position setting operation at a position 1801. When an NFC operation, for example, is installed in each of the device A and the device B, the starting position setting operation may be automatically executed through NFC when the device A and the device B are close to each other, for example.

The starting position setting operation may be executed by one or more methods. For example, in a state in which each of the device A and the device B, such as the apparatus 800 of the terminal 8 or the apparatus 900 of the terminal 9, accesses an identical AP, the starting position setting operation may be executed in response to a “gesture of shaking a device” for example. Also, in a state in which an application of performing a position setting operation is executed, the starting position setting operation may also be executed in such a manner that each of the device A and the device B senses a user gesture, such as on a screen of the display unit 860 of the apparatus 800 of the terminal 8 or on a screen of the display unit 950 of the apparatus 900 of the terminal 9, for example.

When the starting position setting operation is executed, communication information may be exchanged between the device A and the device B and a position of each of the device A and the device B may be initialized to the origin as described above with reference to the operations of FIG. 12. A position of a corresponding group member or device may be stored in each of the device A and the device B, for example.

FIG. 19 illustrates a diagram in which a current position of a device is updated according to exemplary embodiments of the present invention.

As illustrated in FIG. 19, positions of a device A and a device B are moved from the starting position 1801 and, thus, the respective positions of the device A and the device B may be updated through a position updating operation and the above updating may be notified to a counter party device by broadcasting a position sharing message, for example. When a device is receives a position sharing message, the device may update position information of a corresponding device of group information, for example.

Referring to FIG. 19, a current position of the device A is (ax, ay) and a current position of the device B is (bx, by). The device A may store a group member or device and position information of the group member or device, for example, {(B, (bx, by))}, for example.

FIG. 20 illustrates a diagram in which a new device is added as a group member, according to exemplary embodiments of the present invention.

Referring to FIG. 20, the new device C, such as the apparatus 800 of the terminal 8 or the apparatus 900 of the terminal 9, may perform a starting position setting operation through NFC, for example, at a position physically identical or substantially identical to a position of a device B belonging to a position sharing group. For example, the new device C may perform the second operation of FIG. 12, for example, according to exemplary embodiments.

Since the device C is accessing the position sharing group, the device C may store a position of the device C as a position of the device B and store group information that is received from the device B, for example. The device B already belongs to the position sharing group and, thus, may add information associated with the device C to group information and may broadcast relevant information to group members or devices, for example.

In this regard, each of a device A and the device B may receive broadcasted group information and update existing group information, for example.

FIG. 21 illustrates a diagram in which a position of a group member or device is changed, according to exemplary embodiments of the present invention.

Referring to FIG. 21, the position of the device C of FIG. 20 is changed to (cx, cy). The device C may broadcast a message indicating that the position of the device C is changed. Group information stored in the device A may include group members and position information of each group member, and may be expressed as {(B, (bx, by)), (C, (cx, cy))}, for example.

And, in this regard, the device B may receive the broadcast message from the device C, and may update the group information, for example.

The group information stored in the device B after the group information is updated may include group members and position information of each group member, and may be expressed as {(A, (ax, ay)), (C, (cx, cy))}, for example.

FIG. 22 illustrates a diagram in which a first position sharing group and a second position sharing group are merged according to exemplary embodiments of the present invention.

Referring to FIG. 22, a point 2201 denotes a starting position of a first position sharing group 2210, for example, an origin of a coordinate system used by the first position sharing group 2210.

Also, in FIG. 22, a point 2202 denotes a starting position of the second position sharing group 2220, for example, an origin of a coordinate system used by the second position sharing group 2220.

The first position sharing group 2210 may include the device A, the device B, and the device C. The second position sharing group 2220 may include a device D, a device E, and a device F, such as the apparatus 800 of the terminal 8 or the apparatus 900 of the terminal 9.

When each of the device B and the device D initiates a starting position setting operation through NFC and the like, each of the device B and the device D may perform the fourth operation of FIG. 12 since both the device B and the device D belong to a position sharing group, for example.

FIG. 23 illustrates a diagram in which an origin update of a device belonging to a position sharing group and a device belonging to another position sharing group is completed according to exemplary embodiments of the present invention.

In FIG. 23 an origin update of each of the device B belonging to a position sharing group 2310 and the device D belonging to a position sharing group 2320 is completed. The device B may correct position information of the device B, for example, e.g. a host device user's position information (“my position” information), to be (0, 0) by employing a position of the device B as an origin, and may also correct position values of devices within the position sharing group 2310, for example. When the device B broadcasts an origin change message to group members or devices, the device A and the device C belonging to the same position sharing group 2310 may perform an origin update. Similarly, the device D may correct position information by employing a position of the device D as an origin. Also, the device E and the device F belonging to the same position sharing group 2320 may perform origin update, for example.

Continuing with reference to FIG. 23, the device B and the device D are positioned at a physically identical or a substantially identical position, and positions of the device B and the device D are used as an origin 2301, for example. Therefore, the devices A, B, C, D, E, and F present or located in different coordinate systems, the devices A, B and C being present or located in a first coordinate system and the devices D, E and F being present or located in a second coordinate system, may be corrected using the same coordinate system, for example, according to exemplary embodiments.

FIG. 24 illustrates a result of updating group information and correcting an origin according to exemplary embodiments of the present invention.

Referring to FIG. 24, a diagram in which a result of updating group information of FIG. 23 and correcting an origin is illustrated where a merged position sharing group 2410 may be generated based on a corrected origin 2401, according to exemplary embodiments.

For example, as illustrated in FIG. 24, a current position of the device A may be corrected to be (ax2, ay2), and information associated with a position sharing group, stored in the device A, may be expressed as {(B, (0, 0)), (C, (cx2, cy2)), (D, (0, 0)), (E, (ex2, ey2)), (F, fx2, fy2)}. Also, a current position of the devices B, C, D, E and F may be corrected and information associated with a position sharing group, stored in the respective devices B, C, D, E and F may be expressed as indicated in FIG. 24, for example.

FIG. 25 illustrates a diagram in which a position of one or more devices belonging to a position sharing group is changed according to exemplary embodiments of the present invention.

Referring to FIG. 25, devices A, B, C, D, E, and F are members or devices that belong to a position sharing group 2510 based on an origin 2501, and FIG. 25 illustrates a position of the device B and of the device D of FIG. 24 is changed. For example, a position of the device B is (bx2, by2) and a position of the device D is (dx2, dy2). Group information, such as of the position sharing group 2510 may be changed based on the position (bx2, by2) of the device B and the position (dx2, dy2) of the device D, for example, according to exemplary embodiments.

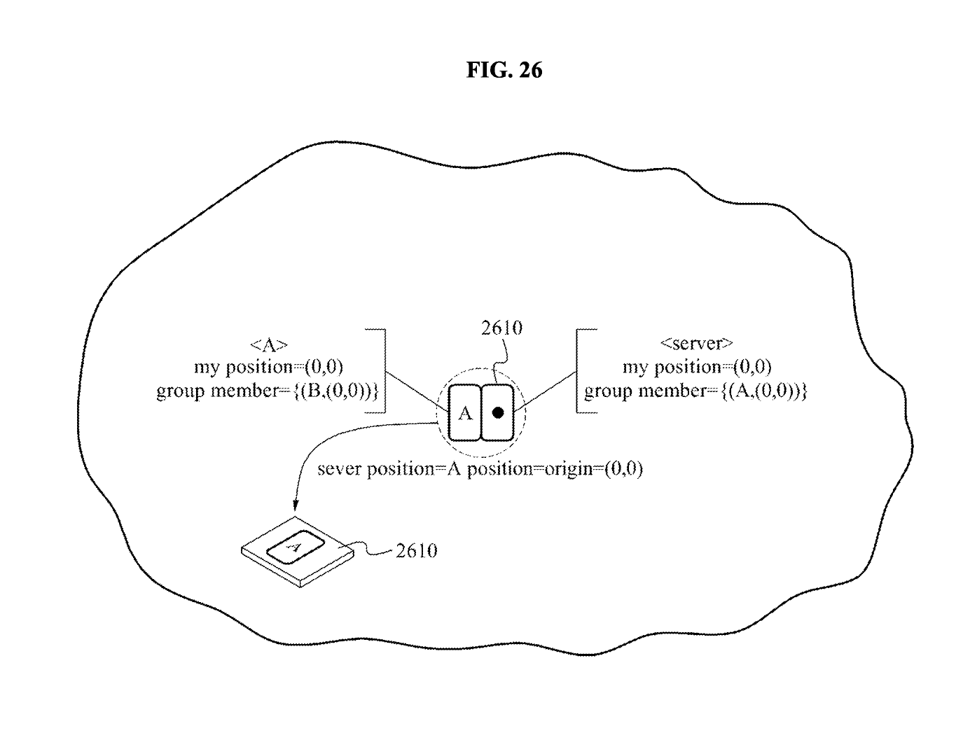

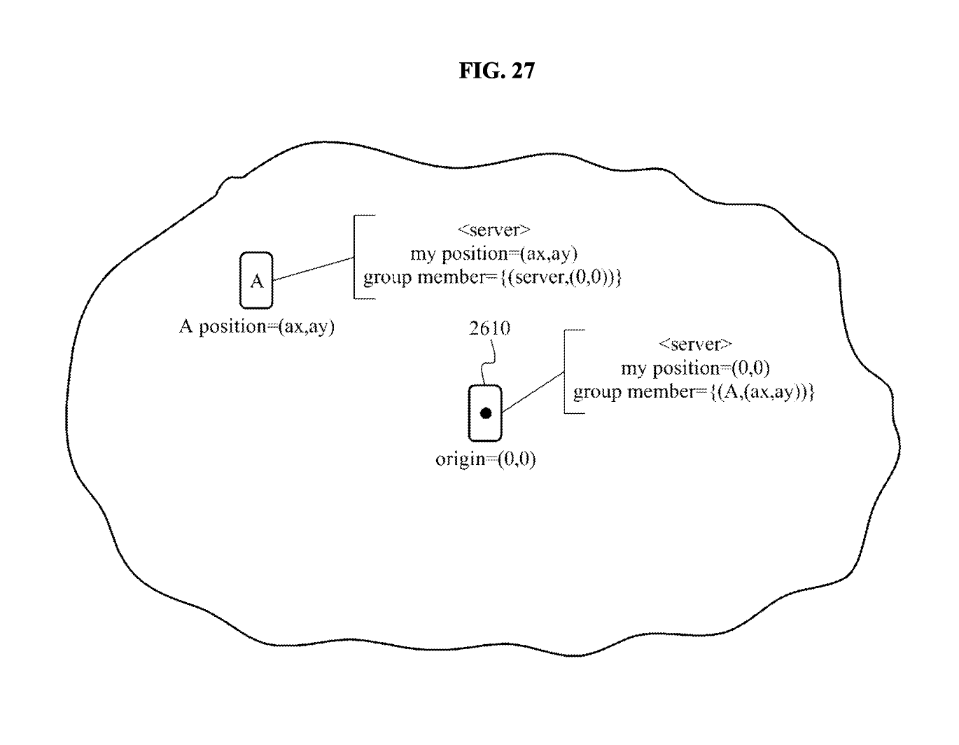

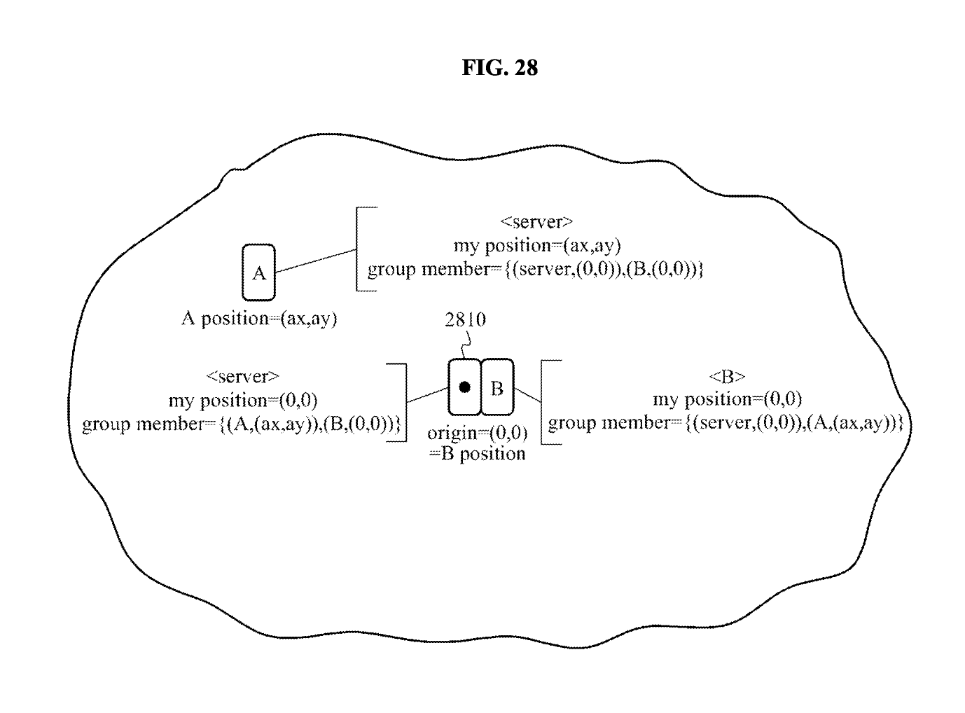

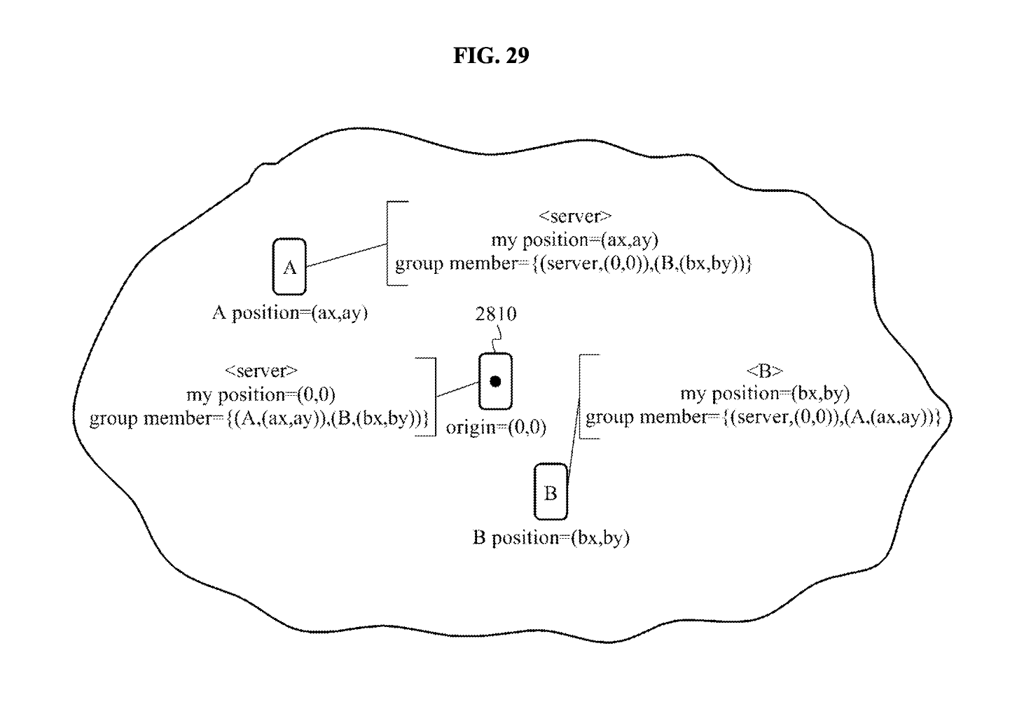

FIG. 26, FIG. 27, FIG. 28 and FIG. 29 are diagrams to illustrate operations for generating a position sharing group and detecting a position using a server device according to is exemplary embodiments of the present invention.

Even though the examples of FIG. 26 through FIG. 29 are described based on a 2D coordinate system for ease of description, the exemplary embodiments are not limited to the 2D coordinate system and may be readily expanded to a 3D coordinate system, for example, according to exemplary embodiments and, therefore, should not be construed in a limiting sense.

Referring to FIG. 26, a server device 2610 may be fixed at a predetermined position. The device A may trigger a starting position setting operation in a state in which the device A is positioned at a position physically identical or substantially identical to the server device 2610. For example, a user of the device A may trigger the starting position setting operation in a state in which the device A is placed on the server device 2610, for example.

And, in this regard, the device A may register information associated with the device A to the server device 2610, for example.

Continuing with reference to FIG. 27, the diagram illustrates the position of the device A of FIG. 26 is changed to be (ax, ay). And the device A may transmit changed position information to the server device 2610, for example.

FIG. 28 illustrates a diagram in which a new device, such as the device B, is registered to a server device 2810.

In FIG. 28, the server device 2810 may notify the device A about the device B being registered to a position sharing group. The server device 2810 may also notify the device B about position information of the device A, for example.

FIG. 29 illustrates a diagram in which a position of the device B of FIG. 28 is changed. The device B may transmit a current position of the device B to the server device 2810. And the server device 2810 may notify the device A about position information of the device B, for example.

Continuing with reference to FIG. 29, the server device 2810 may store and maintain information associated with the position sharing group. For example, group information stored in the server device 2810 may be expressed as {(A, (ax, ay)), (B, (bx, by))}.

FIG. 30, FIG. 31, FIG. 32, FIG. 33, FIG. 34, FIG. 35, FIG. 36, FIG. 37A, FIG. 37B, FIG. 38, FIG. 39 including images (A) and (B), FIG. 40 including images (A) and (B) and FIG. 41 are diagrams to illustrate applications to perform position detection and communication, according to exemplary embodiments of the present invention.

FIG. 30 through FIG. 32 illustrate members or devices belonging to a position sharing groups are displayed as visual objects, such as on a screen of the display unit 860 of the apparatus 800 of the terminal 8 or on a screen of the display unit 950 of the apparatus 900 of the terminal 9, for example.

In this regard, a device may verify or determine a current position from a starting position using a motion recognizing sensor, and may verify or determine a current position of a corresponding device based on information received through communication, for example. And the device may display, on a screen, an object indicating the corresponding device.

Also, the starting position may be set to be physically identical or substantially identical to a starting position of the corresponding device. And the motion recognizing sensor, such as may be included in the sensing unit 810 of the apparatus 800 of the terminal 8, may measure a positional change amount from the starting position. Also, the device may calculate or determine the current position of the device based on the measured positional change amount, for example.

When displaying objects on the screen, such as on a screen of the display unit 860 of the apparatus 800 of the terminal 8 or on a screen of the display unit 950 of the apparatus 900 of the terminal 9, for example, the device may display an object based on a distance between devices and a direction of another device that is positioned from the device. In this regard, an inter-device distance or direction information may be displayed, for example, according to exemplary embodiments. When displaying a position, the device may display the position based on a position of the device and a direction of the device placed. When conditions change, a position of a corresponding device may be dynamically updated. A display method, such as to display the position based on a position of the device and a direction of the device, may also vary in response to a user input to the device, for example, according to exemplary embodiments.

For example, using a smart phone icon, the device may display an object indicating another device. Also, the device may also display device information, for example, coordinates, in the object indicating the other device, or may display the object by including a variety of graphical elements, for example.

FIG. 30 illustrates a device in which a relative position of each of members or devices belonging to a position sharing group is three-dimensionally displayed, for example, according to exemplary embodiments.

Referring to FIG. 30, a device 3000, such as terminal 8 including the apparatus 800 or the terminal 9 including the apparatus 900, for example, may display, on a screen 3020, such as on a screen of the display unit 860 of the apparatus 800 of the terminal 8 or on a screen of the display unit 950 of the apparatus 900 of the terminal 9, for example, an object 3001, i.e. “Me”, for expressing the device 3000 and objects 3002 through 3010 for expressing corresponding devices, such as belonging to a position sharing group.

FIG. 31 illustrates an example of displaying directions of corresponding devices. Referring to FIG. 31, a device 3100, such as terminal 8 including the apparatus 800 or the terminal 9 including the apparatus 900, for example, may display, on a screen 3020, such as on a screen of the display unit 860 of the apparatus 800 of the terminal 8 or on a screen of the display unit 950 of the apparatus 900 of the terminal 9, for example, objects 3102 through 3109 for indicating directions of corresponding devices based on a position 3101 of the device 3100, for example.

Continuing with reference to FIG. 31, the objects 3102 through 3109 are displayed to be transparent, for example, and, thus, may not obstruct usage of the device 3100, according to exemplary embodiments.

Also, the objects 3102 through 3109 may be displayed on a single screen that is displayed on a reference or a selected area of the screen 3020, for example.

FIG. 32 illustrates displaying a position of a corresponding device, such as belonging to a position sharing group, through augmented reality.

In FIG. 32, objects 3202 through 3207, such as corresponding to corresponding devices, may be displayed on the screen 3220 of the device 3200, such as on a screen of the display unit 860 of the apparatus 800 of the terminal 8 or on a screen of the display unit 950 of the apparatus 900 of the terminal 9, for example, through augmented reality.

The device 3200 may be aware of a position of the device 3200 and a direction faced by a camera of the device 3200, using sensor information, and may also be aware of position information of a corresponding device, such as the devices corresponding to the objects 3202 through 3207. In generally, an augmented reality scheme may analyze image information that is obtained through the camera and thereby display the analyzed image information on a screen, such as on the screen 3220. Therefore, according to exemplary embodiments, it may be possible to minimize resources for analysis of image information, for example.

FIG. 33 illustrates selecting a corresponding device based on a direction in which the corresponding device is positioned, according to exemplary embodiments.

In this regard, to transmit selected content to another device, an operation of selecting a target device may be required. In general, the process of selecting a target device may include, for example, displaying a list of target devices on a user interface of a device and selecting a desired device from among the list of target devices. However, the above operations may be inconvenient in that a user of a device may need to perform input a plurality of times and to designate different IDs or names for identifying each device.

According to exemplary embodiments, a device may be aware of a relative position of another device, and it is possible to be aware of a direction in which the other device is positioned based on a position of the device, for example. Therefore, when a user of a device inputs, into the device, a reference gesture indicating a direction, it is possible to select a device to which content is desired to be transmitted or received, from among devices positioned in the above direction. Using the above operation, methods for selecting a targeting device may be simplified, according to exemplary embodiments. A corresponding device, such as belonging to a position sharing group, may be identified based on an actual direction, instead of being identified based on an ID or a name. Accordingly, usage efficiency may be enhanced, according to exemplary embodiments.

When a device selects a reference direction in response to a user gesture, the selected direction may be a single line straightly extended from the device. A position of the other device is known and may be expressed as a single point. Therefore, a shortest distance from the single point to the straight line may be easily calculated or determined using mathematical principles, for example. By selecting a device positioned at a position corresponding to the shortest distance or by selecting devices having a reference distance less than or equal to a reference threshold, it is possible to identify a target device to which content is to be transmitted or from which content is to be received, according to exemplary embodiments.

For example, referring to FIG. 33, when a touch gesture of drawing a straight line 3320 from an object 3310 displayed on a touch screen of a device 3305 of a user, e.g. “Me”, occurs, such as on a screen of the display unit 860 of the apparatus 800 of the terminal 8 or on a screen of the display unit 950 of the apparatus 900 of the terminal 9, for example, distances between the straight line 3320 and positions of the respective devices, namely a device 3330 (device A), a device 3350 (device B), and a device 3350 (device C) are d1, d2, and d3. Here, d2 is smallest distance and, thus, the device B may be selected as a target device, for example.

FIG. 34 and FIG. 35 illustrate processing a directional metaphor gesture based on position information of corresponding devices, according to exemplary embodiments.

In this regard, a gesture may be any of various types, including the directional metaphor gesture may include a plurality of gestures and may, for example, include a flicking gesture. The flicking gesture indicates a gesture of quickly dragging a touch screen, such as on a screen of the display unit 860 of the apparatus 800 of the terminal 8 or on a screen of the display unit 950 of the apparatus 900 of the terminal 9, for example, in a reference direction from a touched device. Referring to FIG. 34, when flicking is performed from a device 3410 in a direction in which another device 3430 is present, the flicking may be regarded that the user of the device 3410 inputs the reference direction. The device 3410 may select the closest device 3430 in the direction from among devices 3420, 3430, and 3440, and may transmit selected content to or receive selected content from the selected device 3430, for example.

The device 3410 may also select a corresponding device, such as belonging to a position sharing group, by recognizing a direction in which a device is positioned. For example, a user of a device, such as device 3410, may input a directional metaphor gesture by fitting or determining a direction of a device of the user to be suitable for the corresponding device 3430 and touching a “send” button on a touch screen or by executing a “send” operation or a “receive” operation, such as to receive content from the corresponding device, using a separate button and the like, for example, according to exemplary embodiments.

FIG. 35 illustrates selecting a corresponding device 3520 from among corresponding devices 3520, 3530, and 3540 through flicking on a touch screen of a device 3510, such as in a direction of the device 3520, for example, according to exemplary embodiments, such as to transmit to or receive content from one or more corresponding devices, for example.

As illustrated in FIG. 34 and FIG. 35, when position information of a corresponding device is known, methods for selecting the corresponding device may be set or determined using any of various schemes or operations, for example according to exemplary embodiments.

FIG. 36 illustrates a user interface displayed when a plurality of devices is positioned in a selected direction, according to exemplary embodiments.

Referring to FIG. 36, when devices A, B, and C are positioned in a direction selected as illustrated in FIG. 34 or FIG. 35, a device 3600 such the apparatus 800 of the terminal 8 or the apparatus 900 of the terminal 9, may also display various objects 3601 through 3606 on a display unit 3610, such as on a screen of the display unit 860 of the apparatus 800 of the terminal 8 or on a screen of the display unit 950 of the apparatus 900 of the terminal 9. For example, when a plurality of members or devices is present in a direction selected in response to a user gesture on the screen of the display unit 3610, a user interface for selecting a member or device, such as to select one or more devices may be displayed. For example, on the screen of the display unit 3610, the object 3601 advises a user of the device 3600 that a plurality of devices is present in the user's selected direction, such as devices A, B and C corresponding to objects 3603, 3604 and 3605, respectively, such as for communication of content. In this regard, for example, the user of the device 3600 may select one or more, or none, of devices A, B, or C, by selecting the corresponding objects 3603, 3604, or 3605, or all of the devices A, B, and C by the selecting the “All” object 3602” or none of the devices A, B and C by selecting the “Cancel” object 3606, according to exemplary embodiments.

FIGS. 37A and 37B illustrate user interfaces displayed when receiving content from a corresponding device, such as belonging to a position sharing group, according to exemplary embodiments.

Referring to FIG. 37A, a device 3700, such as the apparatus 800 of the terminal 8 or the apparatus 900 of the terminal 9, may display, on a display unit 3710, such as on a screen of the display unit 860 of the apparatus 800 of the terminal 8 or on a screen of the display unit 950 of the apparatus 900 of the terminal 9, an object 3720 indicating that content is received from a corresponding device, such as belonging to a position sharing group, according to exemplary embodiments.

Referring to FIG. 37A, a user of the device 3700 may be aware of a direction in which the corresponding device is positioned through an object 3701 indicating the corresponding device.

FIG. 37B illustrates an object 3730 asking whether to receive content from a corresponding device. Referring to FIG. 37B, a user of the device 3700 may be aware of a direction in which the corresponding device is positioned through an object 3702 indicating the corresponding device, according to exemplary embodiments.

For example, the device 3700 may display a current position of a corresponding device on a screen, such as the screen 3710, and may display an object indicating that content is received from the corresponding device or an object asking whether to receive the content from the corresponding device, similar to the object 3730 displayed on the screen 3710 of the device 3700, according to exemplary embodiments.

FIG. 38 illustrates splitting a screen output from a single device and thereby displaying split screens on a plurality of devices.

FIG. 38 illustrates a total of nine members or devices 3821 through 3829, such as the apparatus 800 of the terminal 8 or the apparatus 900 of the terminal 9, which are included in a position sharing group, and the corresponding positions of the devices 3821 through 3829.

A device 3810, such as the apparatus 800 of the terminal 8 or the apparatus 900 of the terminal 9, such as a host device, for example, may determine the number of split screens and a size thereof based on the number of members or devices within the position sharing group, according to exemplary embodiments.

As illustrated in FIG. 38, for example, the member or device 3821 may display a screen corresponding to a split screen 1 of the screen 3815 displayed on a display unit of the device 3810. Similarly, the members 3822 through 3829 may display split screens 2 through 9 displayed on the display unit of the device 3810, respectively. The screen 3815 and the screens of the devices 3821 through 3829 may be the same or similar to a screen of the display unit 860 of the apparatus 800 of the terminal 8 or a screen of the display unit 950 of the apparatus 900 of the terminal 9, for example.

As illustrated in FIG. 38, content to be split and thereby displayed on a screen may be shared by all of the devices, and may also be stored in a separate server, for example, according to exemplary embodiments.

Also, in this regard, a procedure of splitting and thereby displaying a screen may be performed using any of various methods. For example, when information associated with the number of split screens and a size thereof is shared, such as with members or devices belonging to a position sharing group, each of corresponding devices may display a corresponding split screen based on position information of the corresponding device.

For example, the device 3810 may request the member or device 3821 to display the split screen 1 based on position information of the other members or devices 3821 through 3829. The device 3810 may display information associated with the number of split screens and a size thereof, and the member or device 3821 may determine that the member or device 3821 needs to display the split screen 1 based on a position of the member 3821 and positions of the other members or devices 3821 through 3829, for example, according to exemplary embodiments.

According to the splitting of a screen output from a single device and displaying split screens on a plurality of devices, as illustrated in FIG. 38, it is possible to display content to be viewed on a relatively wide screen, and to split a single item of content for each area and thereby perform an individual operation thereof, such as in relation to the split content displayed on a corresponding split screen, according to exemplary embodiments.

Continuing now with reference to FIG. 39, image (A) of FIG. 39 illustrates splitting and thereby displaying a map on a first device 3910 on a screen 3915 and on a second device 3920 on a screen 3925, such as on a screen of the display unit 860 of the apparatus 800 of the terminal 8 or on a screen of the display unit 950 of the apparatus 900 of the terminal 9, for example.

When positions of the first device 3910 and the second device 3920 are changed based on a y axis as illustrated in image (B) of FIG. 39, a display screen may need to be modified, for example.

Also, according to an exemplary embodiment of the present invention, the first device 3910 and the second device 3920 may exchange a coordinate value or coordinate values of the content being displayed. In this regard, referring to FIG. 40, as illustrated from images (A) and (B), the coordinate values of the content, and therefore the content, displayed on the screen 3915 of the device 3910 and on the screen 3925 of the device 3920 in image (A) has been exchanged as illustrated on the screen 3915 of the device 3910 and on the screen 3925 of the device 3920 in image (B). Therefore, as illustrated in image (B) of FIG. 40, each of the first device 3910 and the second device 3920 may correct a screen to be split and thereby be disposed, based on a change in a position, for example, according to exemplary embodiments.

FIG. 41 illustrates user interfaces for sharing of content and splitting and displaying of a screen, according to exemplary embodiments.

Referring to FIG. 41, a device may display on a screen 4130, such as on a screen of the display unit 860 of the apparatus 800 of the terminal 8 or on a screen of the display unit 950 of the apparatus 900 of the terminal 9, for example, a user interface 4110 for asking a user of the device whether to share content with a member or device within a position sharing group.

When a user of the device selects to share the content, the device, as indicated by the arrow 4115, may also display a user interface 4120 for asking the user of the device whether to split and thereby display the content with the member or device within the position sharing group, for example.

Also, exemplary embodiments of the present invention may be applied to any of various of fields, uses, or applications.

For example, the exemplary embodiments of the present invention may be employed to verify or determine a position of a friend when a user and the friend need to separately move from each other, such as for shopping different items of products within a shopping center for a short period of time. Also, it is possible to track a position of a child in a playground, and to issue a notice when the child stays away by at least or moves beyond a reference distance. Accordingly, it may be possible by position verification or position tracking, according to exemplary embodiments, to prevent the occurrence of a missing or a lost child.

Also, by setting a reference single device within a position sharing group as an inducement reference device and by setting another device as an inducement target device, it is possible to move a position or induce a movement so that a distance between the devices may be maintained. In this regard, when the inducement target device is autonomously movable, it is possible to move a target device up to a destination or to maintain a reference distance from the target device by setting, as the target device, the inducement reference device or another device within the position sharing group, according to exemplary embodiments.

Also, as an example of commercial applications of the present invention, it is possible, for example, to install a fixed server device at an entrance of or elsewhere within a movie screen within a theater. In this regard, the fixed server device may be used for a system of transforming devices of or corresponding to a group to seats within the movie screen using an NFC tag or a QR code, and finding a reserved seat within the movie cinema. By displaying, on a screen, an entrance and an exit of the movie screen, a reserved seat and a current position of a user, a travel path, and the like, the user may be induced to easily and quickly find the seat, for example.

According to exemplary embodiments of the present invention, it is possible to share a mutual position between devices without using GPS information.

Also, according to exemplary embodiments of the present invention, it is possible to share a mutual position between devices through a relatively simple operation, without typically using separate additional equipment.

Also, according to exemplary embodiments of the present invention, it is possible to relatively easily detect a current position of a corresponding device and to perform communication in an indoor environment, for example.

Also, according to exemplary embodiments, in a narrow indoor environment in which it is or may be typically difficult to employ a GPS, it is possible to verify or determine a mutual position between devices using a sensor and communication equipment generally provided in a smart device, and to enhance user efficiency, for example.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to perform position detection and communication, the terminal comprising:
a sensing unit to determine a positional change amount of the terminal from a starting position;
a position calculating unit to determine a current position of at least one of the terminal or a host device based on the determined positional change amount;
a control unit to set a starting position of the terminal and to update the current position of the terminal, and to control performing position detection and communication of the terminal; and
a communication unit to share the determined current position through communication with at least one external device.

2. The terminal of claim 1, wherein
the communication unit receives from the at least one external device information associated with the current position of the at least one external device based on the starting position.

3. The terminal of claim 1, wherein
the communication unit receives a broadcast message from at least one external device comprising a position sharing group with the terminal.

4. The terminal of claim 1, wherein
the control unit sets the starting position of the terminal by accessing position information through the communication unit from the at least one external device comprising a position sharing group with the terminal.

5. The terminal of claim 1, wherein
the communication unit comprises a near field communication (NFC) module to access information from or transmit information to the at least one external device to communicate with the at least one external device.

6. The terminal of claim 1, further comprising:
a gesture recognizing unit to recognize a gesture input to the terminal to transmit content to or receive content from a selected at least one device of a position sharing group based on at least one of a type or a direction of the received gesture.

7. A terminal to perform position detection and communication in a position sharing group, the terminal comprising:
a position sharing group setting unit to set the position sharing group comprising the terminal and at least one corresponding device;
a current position verifying unit to verify a current position of the terminal and the current position of the at least one corresponding device based on a starting position of the terminal; and
a control unit to control updating the current position of the terminal and to control performing position detection and communication of the terminal.

8. The terminal of claim 7, further comprising:
a sensing unit to determine a positional change amount of the terminal from the starting position to determine a current position of the terminal in the position sharing group.

9. The terminal of claim 7, further comprising:
a gesture recognizing unit to recognize a gesture input to the terminal to transmit content to or receive content from a selected at least one device of the position sharing group based on at least one of a type or a direction of the received gesture.

10. The terminal of claim 7, further comprising:
a starting position setting unit to set an origin of a coordinate system as the starting position,
wherein the current position verifying unit verifies the current position of the terminal and the at least one corresponding device comprising the position sharing group based on the starting position.

11. The terminal of claim 7, wherein
the current position verifying unit determines a positional change amount from the starting position of the terminal and determines the current position of the terminal based on the determined positional change amount.

12. The terminal of claim 7, wherein
the current position verifying unit updates information associated with the current position of the at least one corresponding device.

13. The terminal of claim 7, further comprising:
a display unit to display a current position of one or more of the at least one corresponding device and the terminal comprising the position sharing group.

14. A method for performing position detection and communication of a terminal, the method comprising:
determining a positional change amount of the terminal with respect to a starting position;
determining a current position of at least one of the terminal and a host device based on the determined positional change amount;
updating the current position of the terminal based on the determined current position; and
sharing the determined current position through communication with at least one external device.

15. The method of claim 14, further comprising:
changing the starting position and correcting current position information of the terminal based on occurrence of a starting position update event.

16. The method of claim 14, further comprising:
receiving, by the terminal, a broadcast message from at least one external device comprising a position sharing group with the terminal; and
based on the received broadcast message, updating information associated with a position sharing group.

17. The method of claim 14, further comprising:
selecting a corresponding terminal of a position sharing group according to a selected direction, the selected corresponding terminal being disposed along the selected direction.

18. A method for performing position detection and communication of a terminal in a position sharing group, the method comprising:
setting a position sharing group comprising a terminal and at least one corresponding device;
setting a starting position of the terminal through communication with the at least one of a corresponding device or a server device associated with the position sharing group; and
verifying a current position of the terminal and a current position of the at least one corresponding device based on the set starting position.

19. The method of claim 18, wherein
the verifying is based on a coordinate system using the starting position as an origin of the coordinate system.

20. The method of claim 19, further comprising:
updating the starting position when the current position of the terminal and the current position of the at least one external device comprising the position sharing group are separate from the origin by at least a reference distance.

21. The method of claim 18, further comprising:
transmitting to or receiving from a selected at least one corresponding device of the position sharing group selected content based on at least one of a type or a direction of a received gesture.

22. The method of claim 18, further comprising:
forming a new position sharing group including the terminal and at least one corresponding device based on current position information; and
sharing information associated with the new position sharing group with the at least one corresponding device of the new position sharing group.

23. The method of claim 18, further comprising:
displaying content the terminal and the at least one corresponding device according to positions of the terminal and the at least one corresponding device, the content being split among the terminal and the at least one corresponding device.

24. The method of claim 18, further comprising:
exchanging, by the terminal, content displayed on a screen of a display unit of the terminal with content displayed on a corresponding device of the position sharing group based on a changed position of the terminal.

25. The method of claim 18, further comprising:
selecting a corresponding terminal of the position sharing group according to a selected direction, the selected corresponding terminal being disposed along the selected direction.
